(19) United States
(12) Patent Application Publication
(10) Pub. No.: US 2007/0212111 A1
(43) Pub. Date: Sep. 13, 2007

(54) Electric charging device, and image forming apparatus

(75) Inventors: Toshiaki Kagawa, Kitakatsuragi-gun (JP); Tohru Sakuwa, Nara-shi (JP); Hideki Ohnishi, Chiba-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/705,038

(22) Filed: Feb. 12, 2007

(30) Foreign Application Priority Data
Feb. 13, 2006 (JP) 2006-35786
Dec. 28, 2006 (JP) 2006-355593

(51) Int. Cl. G03G 15/02; G03G 15/14

(52) U.S. Cl. 399/168; 399/315

(57) ABSTRACT

Ions are produced without causing any accompanying corona discharge by applying, to ion generation needles positioned so as not to contact a photoconductor drum, a voltage higher than or equal to an ion production threshold voltage and lower than a corona discharge threshold voltage. The photoconductor drum is charged by the ions produced. Accordingly, a charging device is provided which is capable of stable charging with high uniformity over a long period whilst reducing the production of ozone, nitrogen oxides, and other discharge byproducts.

This nonprovisional application claims priority under 35 U.S.C. § 119(a) on Patent Applications No. 2006-035786 filed in Japan on Feb. 13, 2006 and No. 2006-355593 filed in Japan on Dec. 28, 2006, the entire contents of which are hereby incorporated by reference.

### FIELD OF THE INVENTION

The present invention relates to an electric charging device capable of highly uniform, temporally stable electric charging while, in discharging, producing ozone, nitrogen oxides, and other byproducts in only limited quantities. The invention relates also to an image forming apparatus incorporating the electric charging device.

### BACKGROUND OF THE INVENTION

Typical conventional electrophotographic image forming apparatuses include an electric charging device of a corona discharge type. The device, for example, acts as an electric charger which uniformly charges a photoconductor or is found in a transfer unit or a paper removal unit. The transfer unit is provided to electrostatically transfer a toner image formed on, for example, a photoconductor to, for example, recording paper. The paper removal unit is provided to peel off, for example, recording paper that is electrostatically sticking to, for example, a photoconductor.

The charging device of a corona discharge type generally contains either a “corotron” or a “scorotron.” A corotron includes: a shield with an opening opposite a charge-target object, such as the photoconductor or the recording paper; and a linear or sawtooth discharge electrode disposed extending in the shield. The corotron charges a charge-target object uniformly by applying high voltage to the discharge electrode to achieve corona discharge. The scorotron includes, between a discharge electrode and a charge-target object, a grid electrode to which a desired voltage is applied to charge the charge-target object uniformly. See Japanese Unexamined Patent Publication 6-11946/1994 (Tokukaihei 6-11946; published Jan. 21, 1994).

FIG. 14 is a schematic illustration of the electric charging mechanism of the conventional charging device of a corona discharge type. As mentioned above, the charging device of a corona discharge type is made up of a linear, sawtooth, or needle discharge electrode 101 and an opposite electrode (discharge destination object) which is, for example, a photoconductor 102 or a grid electrode 103. A high voltage is applied between the discharge electrode 101 with a small curvature radius and the opposite electrode (discharge destination object) to produce a non-uniform electric field between the two electrodes. A strong electric field occurring near the discharge electrode 101 causes local ionization which in turn produces electrons (discharge of electrons through electron avalanche), so as to charge the charge-target object, e.g., the photoconductor 102. The grid electrode 103 is provided there to control the quantities of electrons reaching the charge-target object, e.g., the photoconductor 102. That means some electrons charge the grid electrode 103.

When electrons are released, the conventional charging device of a corona discharge type produces byproducts, such as ozone (O₃) and nitrogen oxides (NOₓ), in large quantities, which is a problem. Specifically, nitrogen molecules (N₂) break into nitrogen atoms (N) due to energy in the release of electrons (e.g., by collision with electrons) and then combine with oxygen molecules (O₂), forming nitrogen oxide (nitrogen dioxide (NO₂)). Likewise, oxygen molecules (O₂) break into oxygen atoms (O) and combine with oxygen molecules (O₂), forming a large quantity of ozone (O₃).

The production of ozone in a large quantity can be a cause for odor, health hazards, degradation of components due to strong oxidation effect, and other problems. The produced nitrogen oxide sticks as ammonium salt (ammonium nitrate) to the photoconductor and can be a cause for a defective image.

In addition, the nitrogen oxide can stick to the grid electrode in the charging device of a corona discharge type, corroding the surface of the grid electrode through oxidation. Byproducts (insulating metal oxides) may accumulate on the grid electrode and disrupt charging uniformity which in turn can lead to degradation of image quality.

A technique of reducing ozone production is disclosed in, for example, Japanese Unexamined Patent Publication 8-160711/1996 (Tokukaihei 8-160711; published Jun. 21, 1996). The charging device comprises: many discharge electrodes arranged in a predetermined axis direction at substantially constant pitches; a high-voltage power supply for applying voltage in excess of discharge threshold voltage to the discharge electrodes; a resistor material disposed between the output electrode of the high-voltage power supply and the discharge electrode; a grid electrode disposed near the discharge electrodes between the discharge electrodes and a charge-target object; an a grid power supply for applying a grid voltage to the grid electrode. The gap between the discharge electrodes and the grid electrode is reduced to 4 mm or less to lower discharge current and thereby restrict the production of ozone.

The technique of Tokukaihei 8-160711 does reduce the discharge current and hence ozone production. However, the ozone production is reduced by a less-than-sufficient quantity. Ozone is still produced at about 1.0 ppm.

The technique of Tokukaihei 8-160711 has other problems too. Byproducts in electron discharge, toner, paper particles, etc. could stick to electrodes. Discharge energy could subject an electrode tip to corrosion and degradation, causing unstable discharge.

Furthermore, since there is only a narrow gap between the discharge electrodes and the charge-target object, charging will likely become irregular in the direction perpendicular to the discharge electrodes due to the pitches by which the discharge electrodes are separated. This problem can be addressed by reducing the pitches between the discharge electrodes. That however will add to the number of discharge electrodes and increases manufacture cost.

Incidentally, Japanese Unexamined Patent Publication (Tokukai) 2005-316395 (published Nov. 10, 2005) discloses charging the surface of a latent image carrier using a carbon nanomaterial. The invention does not involve discharging that obeys Paschen's law.

### SUMMARY OF THE INVENTION

The present invention, conceived to address the conventional problems mentioned above, has an objective of providing an electric charging device and method, as well as an image forming apparatus, incorporating the charging device, capable of highly uniform and stable charging over an extended period of time while, in discharging, producing ozone, nitrogen oxides, and other byproducts in only limited quantities.

The charging device of the present invention, to solve the problems, is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; and the voltage application means applies to the charging electrode a voltage higher than or equal to an ion production threshold voltage and lower than a corona discharge threshold voltage.

The charging device of the present invention may include: a charging electrode positioned so as not to contact a charge-target object provided inside an electrophotographic apparatus; and voltage application means for applying voltage to the charging electrode, wherein: the charge-target object is charged by applying voltage to the charging electrode; the voltage application means applies to the charging electrode a voltage higher than or equal to an ion production threshold voltage; and the charging electrode is separated from the charge-target object by such a distance that the charge-target object can be charged by ions produced by the voltage applied to the charging electrode, the distance being greater than a corona discharge threshold distance.

The charging device of the present invention may include: a charging electrode positioned so as not to contact a charge-target object provided inside an electrophotographic apparatus; and voltage application means for applying voltage to the charging electrode, wherein: the charge-target object is charged by applying voltage to the charging electrode; and the voltage application means applies to the charging electrode a voltage higher than or equal to an ion production threshold voltage and less than an ozone production surge threshold voltage at which ozone starts to be produced in a suddenly increasing quantity.

The charging device of the present invention may include: a charging electrode positioned so as not to contact a charge-target object provided inside an electrophotographic apparatus; and voltage application means for applying voltage to the charging electrode, wherein: the charge-target object is charged by applying voltage to the charging electrode; the voltage application means applies to the charging electrode a voltage higher than or equal to an ion production threshold voltage; and the charging electrode is separated from the charge-target object by such a distance that the charge-target object can be charged by ions produced by the voltage applied to the charging electrode, the distance being greater than an ozone production surge threshold distance at which ozone starts to be produced in a suddenly increasing quantity.

The charging device of the present invention may include: a charging electrode positioned so as not to contact a charge-target object provided inside an electrophotographic apparatus; and voltage application means for applying voltage to the charging electrode, wherein: the charge-target object is charged by applying voltage to the charging electrode; and the voltage application means applies to the charging electrode a voltage higher than or equal to an ion production threshold voltage and less than a current surge threshold voltage at which an electric current which the voltage application means supplies to the charging electrode starts to suddenly increase.

The charging device of the present invention may include: a charging electrode positioned so as not to contact a charge-target object provided inside an electrophotographic apparatus; and voltage application means for applying voltage to the charging electrode, wherein: the charge-target object is charged by applying voltage to the charging electrode; the voltage application means applies to the charging electrode a voltage higher than or equal to an ion production threshold voltage; and the charging electrode is separated from the charge-target object by such a distance that the charge-target object can be charged by ions produced by the voltage applied to the charging electrode, the distance being greater than a current surge threshold distance at which an electric current which the voltage application means supplies to the charging electrode starts to suddenly increase.

The charging device of the present invention may include: a charging electrode positioned so as not to contact a charge-target object provided inside an electrophotographic apparatus; and voltage application means for applying voltage to the charging electrode, wherein: the charge-target object is charged by applying voltage to the charging electrode; and the charge-target object is charged by ions produced by applying the voltage to the charging electrode. wherein: the charge-target object is charged by ions produced by applying to the charging electrode a voltage higher than or equal to an ion production threshold voltage and less than an ozone production surge threshold voltage at which ozone starts to be produced in a suddenly increasing quantity.

Any of these arrangements is capable of charging the charge-target object, producing little ozone and NOₓ. In addition, the discharge byproducts do not stick to the electrodes. The electrode tip is neither corroded nor degraded by discharge energy. The arrangement is capable of stable charging over time and with improved uniformity.

The image forming apparatus of the present invention is an electrophotographic image forming apparatus and charges a photoconductor using any one of the foregoing charging devices.

This arrangement is capable of charging the photoconductor, producing little ozone and NOₓ. In addition, the arrangement is capable of stable charging over time and with improved uniformity.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is an illustration of the electric charging mechanism of a charging device in accordance with an embodiment of the present invention.

FIG. 2 is a cross-sectional view illustrating the structure of an image forming apparatus incorporating a charging device in accordance with an embodiment of the present invention.

FIG. 3 is a side view of a charging device in accordance with an embodiment of the present invention.

FIG. 4 is a front view of a charging device in accordance with an embodiment of the present invention.

FIG. 5 is an illustration of the structure of a negative ion production element used in experiment 1.

FIG. 6(a) is a graph showing results of experiment 1 in the case of no fixed resistor being inserted. FIG. 6(b) is a graph showing results of experiment 1 in the case of a fixed resistor being inserted.

FIG. 7 is a graph showing measurements showing relationship between distance from a charging electrode and the quantity (density) of negative ions for the negative ion production element shown in FIG. 5.

FIG. 8 is an illustration of the structure of an experimental device used in experiment 2.

FIG. 9 is a graph representing the surface potential profile of a photoconductor with a grid electrode and that of a photoconductor with no grid electrode, both taken along the length of the photoconductors, for comparison.

FIGS. 10(a) and 10(b) are graphs showing results of studies of relationship between an applied voltage and the surface potential of a photoconductor, a net current, and ozone production, in the cases of no fixed resistor being inserted and of a fixed resistor being inserted respectively.

FIGS. 11(a) and 11(b) are graphs showing results of studies of the conditions under which only ions are generated and the conditions under which corona discharge occurs, using an applied voltage and the gap between a charge-target object and a charging electrode as parameters, in the cases of no fixed resistor being inserted and of a fixed resistor being inserted respectively.

FIG. 12 is a side view illustrating a variation example of a charging electrode in a charging device in accordance with an embodiment of the present invention.

FIG. 13 is a side view illustrating a variation example of a charging electrode in a charging device in accordance with an embodiment of the present invention.

FIG. 14 is a schematic illustration of the electric charging mechanism of the conventional charging device of a corona discharge type.

FIG. 15(a) is a graph representing the relationship between the applied voltage and the ozone production shown in FIG. 10(a), as well as the rate β of change of increase α in ozone production to increase in an applied voltage. FIG. 15(b) is a graph representing the relationship between the applied voltage and the net current shown in FIG. 10(a), as well as the rate γ of change of increase θ in a net current to increase in an applied voltage.

FIG. 16(a) is a graph representing the relationship between the applied voltage and the ozone production shown in FIG. 10(b), as well as the rate β of change of increase a in ozone production to increase in an applied voltage. FIG. 16(b) is a graph representing the relationship between the applied voltage and the net current shown in FIG. 10(b), as well as the rate γ of change of increase θ in a net current to increase in an applied voltage.

FIGS. 17(a) and 17(b) are graphs representing conditions (that is, an applied voltage and the gap between a charge-target object and a charging electrode) for a charging device in accordance with another embodiment of the present invention under which the charge-target object is charged without causing sudden increase in ozone production or a net current, in the cases of no fixed resistor being inserted and of a fixed resistor being inserted respectively.

### DESCRIPTION OF THE EMBODIMENTS

### Embodiment 1

An embodiment of the present invention will be describe. FIG. 2 is a schematic cross-sectional view illustrating the structure of a copying machine (image forming apparatus) 100 incorporating a charging device 10 in accordance with the present embodiment. The copying machine 100 is an “electrophotographic” image forming apparatus which prints by transferring onto recording paper the toner which is attracted to an electrostatic latent image formed on a photoconductor drum.

As shown in FIG. 2, the copying machine 100 primarily includes a photoconductor drum (charge-target object) 1, a charging device 10, a laser-image writing unit (not shown), a developing device 11, a transfer unit 12, a cleaning device 13, a discharging device (not shown), a fusing device 14, an image capturing unit (not shown), a paper feeding unit for feeding recording paper (not shown), and transport means for transporting the recording paper (not shown). The charging device 10, laser-image writing unit, developing device 11, transfer unit 12, cleaning device 13, and discharging device are located around the photoconductor drum 1.

The charging device 10 acts to charge the surface of the photoconductor drum 1 to a predetermined potential. In the present embodiment, the charging device 10 releases ions to charge the photoconductor drum 1. Details will be given later.

The laser-image writing unit emits a laser beam onto the photoconductor drum 1 (exposes the photoconductor drum 1 to light) to write an electrostatic latent image with the beam scanning the uniformly charged photoconductor drum 1. These actions are all carried out based on the image data captured on the image capturing unit or obtained from an external device.

The developing device 11 supplies toner to the electrostatic latent image formed on the surface of the photoconductor drum 1. The toner visualizes the electrostatic latent image, forming a toner image.

The transfer unit 12 sandwiches the recording paper between itself and the photoconductor drum 1 where the visualized toner image on the photoconductor drum 1 is (electrostatically) transferred onto the recording paper.

The cleaning device 13 removes and collects the toner that remains on the photoconductor drum 1 after the transfer so that a new electrostatic latent image and a toner image can be formed on the photoconductor drum 1. After the toner removal by the cleaning device 13, the discharging device removes electric charge from the surface of the photoconductor drum 1.

The fusing device 14 acts to fuse the transferred toner image onto the recording paper under heat and pressure.

The copying machine 100, thus structured, prints in the following manner.

First, the image capturing unit captures an image of an original (not shown). Meanwhile, the photoconductor drum 1 rotates in the direction indicated by an arrow in FIG. 2 at a predetermined rate (here, 124 mm/s). The charging device 10 charges the surface of the photoconductor drum 1 to a predetermined potential.

Next, the laser-image writing unit emits a laser beam onto the surface of the photoconductor drum 1 in accordance with the image data produced by the image capturing unit from the original. Thus, the laser-image writing unit writes an electrostatic latent image on the surface of the photoconductor drum 1 in accordance with the image data.

Thereafter, the developing device 11 supplies toner to the electrostatic latent image formed on the photoconductor drum 1. The toner attaches to the electrostatic latent image, thereby forming a toner image. The toner is transferred to recording paper by sandwiching the recording paper between the photoconductor drum 1 and a transfer roller which is a part of the transfer unit 12. The recording paper was fed from the paper feeding unit (not shown).

Now, the fusing device 14 fuses the toner to the recording paper which is then ejected to a paper ejection unit (not shown). After the transfer, the toner that remains on the photoconductor drum 1 is removed and collected by the cleaning device 13. These actions enable suitable prints on the recording paper.

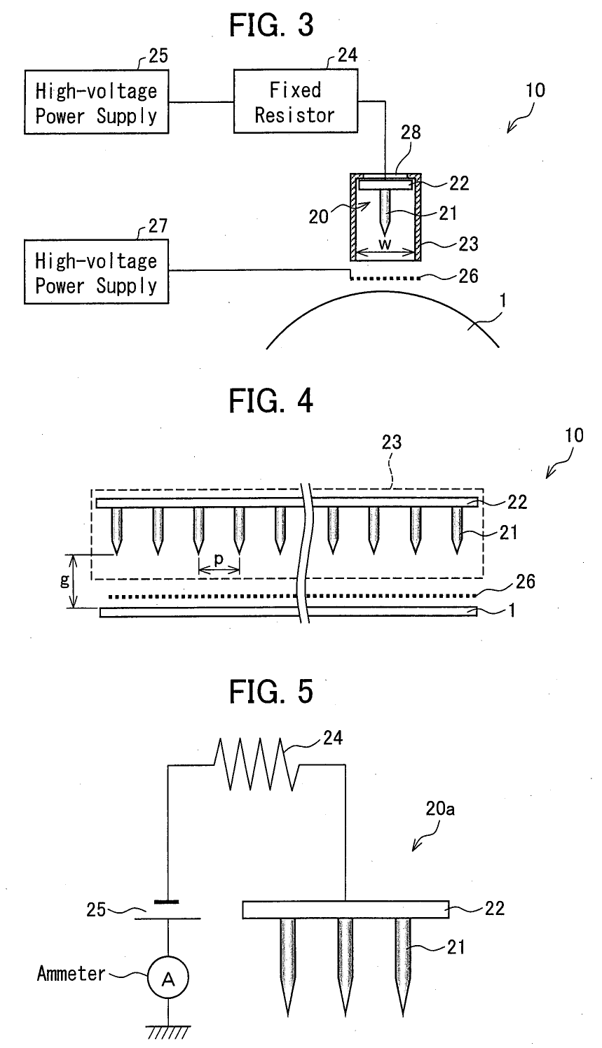

Next, the structure of the charging device 10 will be described in detail. FIG. 3 is a side view of the charging device 10. FIG. 4 is a front view of the charging device 10 (viewed at right angles to the longitudinal direction).

Referring to FIG. 3, the charging device 10 includes a negative ion production element 20, a shield (ion scattering prevention member) 23, a fixed resistor (resistor) 24, a high-voltage power supply (voltage application means) 25, a grid electrode (control electrode) 26, and a high-voltage power supply (control voltage application means) 27.

The negative ion production element 20 has multiple (here, 32) needle-shaped ion generation needles (ion discharge needle or charging electrode) 21 disposed on a metal (here, stainless steel) base frame 22 at a predetermined pitch p. Each ion generation needle 21 is 99.999% tungsten and 1 mm in diameter, and has a curvature radius of 15 μm at the tip. The tips point to the photoconductor drum 1. The pitch p between the needles 21 is 10 mm.

The negative ion production element 20 is positioned close to the photoconductor drum 1 so that the needles 21 are separated by a gap, g=10 mm, from the photoconductor drum 1.

A negative terminal of the high-voltage power supply 25 is connected to the base frame 22 via the fixed resistor 24 (resistance=200 MΩ). Accordingly, a predetermined DC voltage is applied to the ion generation needles 21 attached to the base frame 22. The application of the predetermined DC voltage from the high-voltage power supply 25 to the negative ion production element 20 produces negative ions which charge the photoconductor drum 1 to a predetermined potential (here, −600 V).

The high-voltage power supply 25 supplies a voltage Va (Va<0) with respect to ground potential in image forming. In the present embodiment, Va=−6.5 kV. Throughout this specification, voltage represents the absolute value (magnitude) of a potential difference. Thus, the high-voltage power supply 25 applies |Va|=6.5 kV in the present embodiment.

As the grid electrode 26, that which is used in a digital copying machine manufactured by Sharp Kabushiki Kaisha (product name “AR-625S”) is used. The grid electrode 26 is 0.1-mm thick stainless steel and disposed 1.5 mm away from the photoconductor drum 1. The grid electrode 26 is connected to a negative terminal of the high-voltage power supply 27 so that the high-voltage power supply 27 can apply the predetermined DC voltage (potential difference Vg(<0) with respect to ground potential) to the grid electrode 26. In the present embodiment, Vg=−900 V.

The negative ion production element 20 is enclosed in the shield 23 whose cross-section is like a square U. The shield 23 has an opening facing the grid electrode 26 and an air inlet 28 opposite the opening. In the present embodiment, the opening has a width, w, of 26 mm. The shield 23 is made of resin or another electrically insulating or high resistance material. The material is sufficiently resistant so that no corona discharge occurs with the charging electrode 21. As will be detailed later through experimental examples, the material for the shield 23 is, for example, an insulating ABS resin.

The shield 23, thus provided, restrains negative ions produced by the negative ion production element 20 from scattering and guides the negative ions toward the grid electrode 26, improving ion use efficiency. For example, at least 50% the quantity (density) of the negative ions when the gap g=5 mm is secured so long as gap g≧25 mm. Also, the shield 23 prevents those members located close to the charging device 10 from being accidentally charged.

As mentioned above, the shield 23 is either insulating or highly resistant. Therefore, corona discharge is prevented from occurring with the shield 23 even if the shield 23 is positioned close to the negative ion production element 20. The shield 23 is electrically floating. If the shield 23 is so charged that ion production efficiency falls, however, the shield 23 may be grounded to discharge.

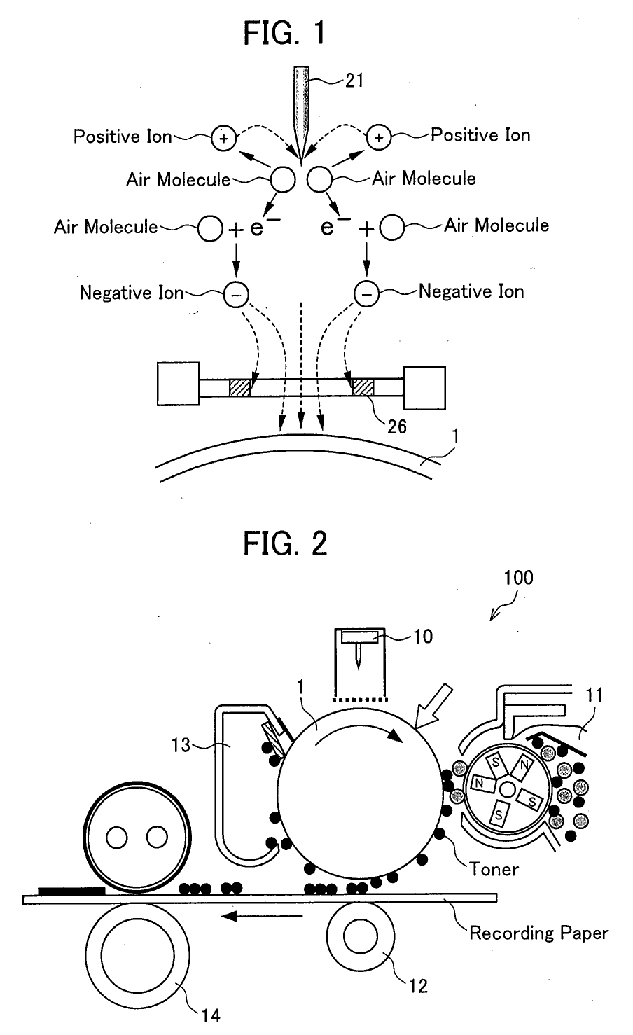

Next, the electric charging mechanism of the charging device 10 by means of negative ions will be described. FIG. 1 illustrates the electric charging mechanism of the charging device 10.

The ion generation needle 21 has a very small curvature radius at its tip. Under high voltage being applied, the ion generation needle 21 generates a very strong electric field around the tip. Note that the needle 21 does not discharge electrons to the photoconductor drum 1 because of the relatively large gap g, and thus weak electric field intensity, between the needle 21 and the photoconductor drum 1 which is the charge-target object (object to be charged) when compared with the conventional charging device of a corona discharge type. However, a strong electric field is created near the tip of the ion generation needle 21, and because of that, airborne molecules, such as those of oxygen, nitrogen, and carbon dioxide, ionize into positive ions and electrons. The dissociated electrons bind with molecules in air (electron attachment), forming negative ions. Some positive ions give its electric charge to the ion generation needle 21, thus converted back to molecules. Others travel to ground.

The produced negative ions move along the electric lines of force formed between the tip of the ion generation needle 21 and the grid electrode 26 or the photoconductor drum 1 and are discharged at the photoconductor drum 1. (Not all the ions are discharged at the photoconductor drum 1 because of a relatively weak electric field being formed when compared with the conventional charging device of a corona discharge type. Some of the ions move in directions other than the direction of the photoconductor drum 1.) The negative ions which reach the surface of the photoconductor drum 1 charges the photoconductor drum 1 to the predetermined potential.

When the grid electrode 26 is in place, the grid electrode 26 catches excess negative ions where the surface potential of the photoconductor drum 1 has dropped (charged) by the negative ions, so that no extra electric charge (electrons) can reach the drum 1. The surface potential of the photoconductor drum 1 therefore is controlled at a substantially constant value.

Since ion production involves a far smaller amount of energy than conventional corona discharge, much fewer nitrogen molecules and oxygen molecules are ionized in ion production than in conventional corona discharge. Production of NOₓ and ozone is greatly reduced.

Now, results of experiment will be described which were conducted to verify that negative ion discharge, instead of corona discharge (electron discharge), is capable of charging the photoconductor drum 1 negatively.

Experiment 1

First, a negative ion production element 20a shown in FIG. 5 was prepared.

The negative ion production element 20a had multiple (here, 3) needle-shaped ion generation needles 21 fixed on a metal (here, stainless steel) base frame 22. Each ion generation needle 21 was 99.999% tungsten and 1 mm in diameter. The needle 21 had a conical portion with a taper angle of 34° and a curvature radius of 15 μm at the tip. Adjacent ion generation needles 21 were separated by a pitch of 10 mm.

The negative ion production element 20a was placed in a free space 1 m in radius in which there was nothing but an air inlet (detailed later). Negative ion production, ozone production, and electric current were measured upon voltage application in two cases: (1) the negative ion production element 20a was connected to a negative terminal of the high-voltage power supply 25; and (2) the negative ion production element 20a was connected to the negative terminal of the high-voltage power supply 25 via the fixed resistor 24 (resistance=200 MΩ). In other words, in one case, there was the fixed resistor 24 (resistance=200 MΩ) between the negative ion production element 20a and the high-voltage power supply 25. In the other, there was none. As additional information, the high-voltage power supply 25 was Trek Inc.'s Model 610C. Also, a negative ion meter AIC-2000 available from Sato Shoji Corporation and an ozone monitor EG2002F available from Ebara Jitsugyo Co., Ltd. were used. Negative ion production was measured 150 mm away from the ion generation needles 21 five seconds after the voltage application to the ion generation needles 21 was started. Ozone production was measured by providing the air inlet 10 mm away from the ion generation needles 21. The measurement was obtained as an average over 12 measurement cycles (12 cycles×15 seconds/cycle=180 seconds or 3 minutes) after the voltage application to the ion generation needles 21 was started.

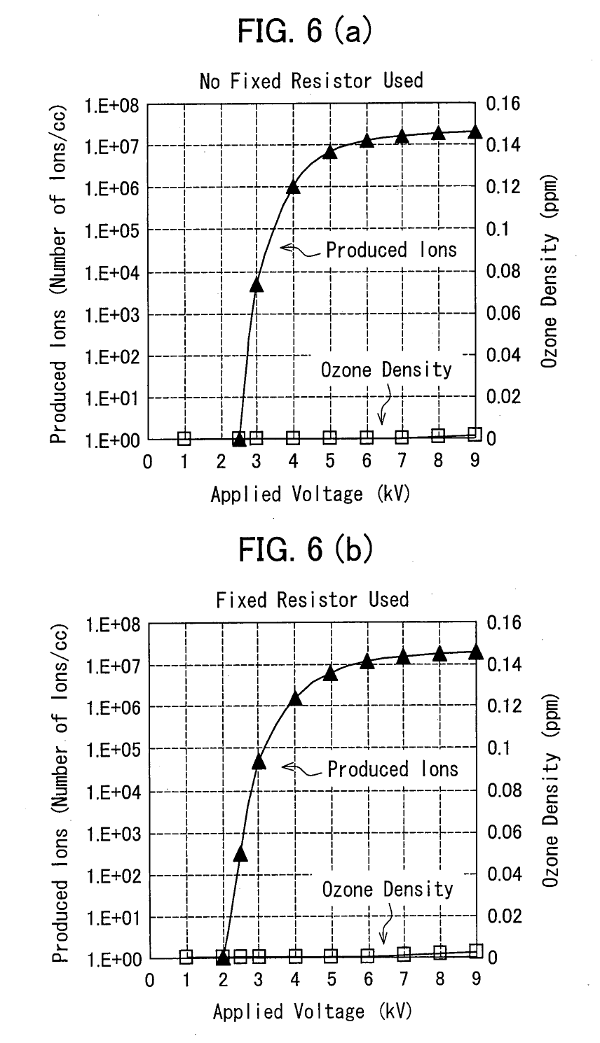

FIG. 6(a) is a graph showing experimental results in the case of no fixed resistor 24 being inserted. FIG. 6(b) is a graph showing experimental results in the case of the fixed resistor 24 being inserted.

FIG. 6(a), showing the case of no fixed resistor 24 being inserted, indicates that negative ion production started (negative ionic measurement started to rise) when the applied voltage exceeded 2.5 kV (i.e., when Va≦−2.5 kV). FIG. 6(b), showing the case of the fixed resistor 24 being inserted, indicates that negative ion production started when the applied voltage exceeded 2 kV (i.e., when Va≦−2.0 kV). In both cases, the quantity of negative ion production (quantity of ions produced) suddenly increased with increase in the applied voltage (increase in the absolute value of the potential difference Va relative to ground potential) and reached saturation at about 1×10⁷ ions/cc. Also in both cases, almost no ozone was produced. Ozone production dropped by large quantities when compared with the conventional charging device of a corona discharge type.

These results demonstrate that high voltage application to the needle-shaped negative ion production element 20a shown in FIG. 5 with no discharge destination object in the surroundings produces a large quantity of negative ions with almost no ozone being produced (that is, ozone production being reduced by large quantities).

The negative ion production threshold voltage was somewhat lower when the fixed resistor 24 was inserted than when it was not, presumably for the following reasons. The ions are produced by difference in potential between air and the ion generation needles 21 with the air acting as a virtual positive electrode. Since the impedance of the air is very unstable, ion production becomes unstable in a region of impedance where the ion production starts at low applied voltage if no fixed resistor 24 is provided. The insertion of the fixed resistor 24 stabilizes the overall impedance inclusive of that of the air, which in turn stabilizes the ion production.

Next, the fixed resistor 24 was inserted, and the applied voltage was set to 3 kV (Va=−3 kV). Under these conditions, the quantity (density) of negative ions was measured in relation with a distance L from the ion generation needles 21. FIG. 7 is a graphical representation of results. The quantity of negative ions is shown in relative values for L>5 mm, taking the quantity of negative ions when L=0.5 mm to be 100%.

As can be seen from the figure, the density of negative ions decreased with increasing L. Also from FIG. 7, at least 50% the quantity (density) of negative ions when L=5 mm is secured so long as L≦25 mm.

Experiment 2

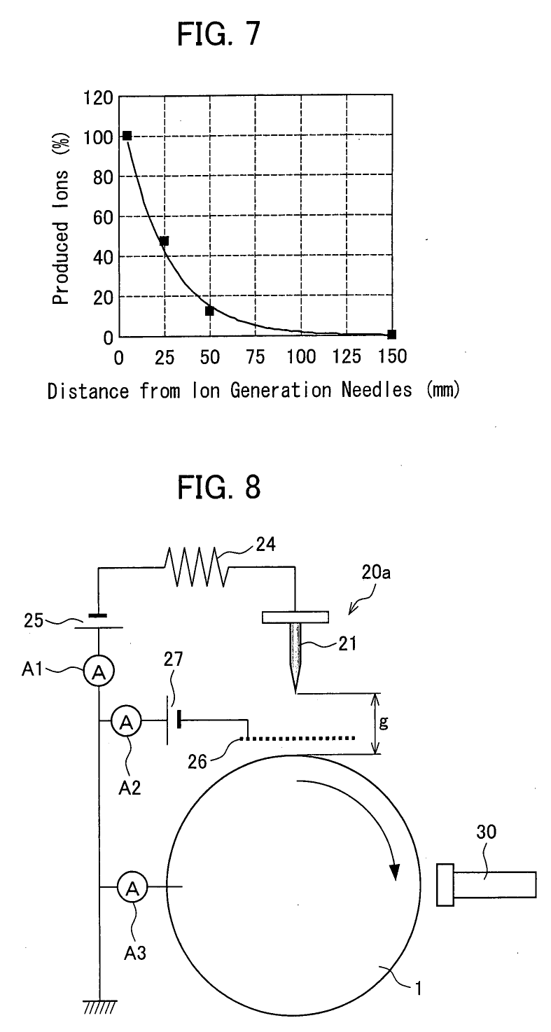

Next, a charging characteristic was measured by experiment on the photoconductor drum 1 using the negative ion production element 20a. First, the experimental device will be described in reference to FIG. 8.

The photoconductor drum 1 was an organic photoconductor (OPC) 30 mm in diameter and 30 μm in film thickness (the photoconductor drum used in a color copying machine manufactured by Sharp Kabushiki Kaisha (product name “MX-2300”)). The drum 1 was so mounted that it could rotate at a given rotation speed. The negative ion production element 20a was placed at a predetermined gap g away from the drum 1. The photoconductor drum 1 and the negative ion production element 20a were so placed in a sealed acrylic enclosure measuring 40 cm wide by 25 cm high by 80 cm long that the negative ion production element 20a could be positioned at the center of the enclosure. The negative ion production element 20a was mounted to a stage (not shown) which could be moved parallel to the length of the photoconductor so that the gap g could be set to any value from 0 to 30 mm. The current flow through the negative ion production element 20a (net current) was measured with an ammeter A1.

Between the photoconductor drum 1 and the ion generation needles 21 of the negative ion production element 20a was provided a 0.1-mm thick, stainless steel grid electrode 26 used in AR-625S manufactured by Sharp Kabushiki Kaisha. The electrode 26 had 26-mm wide (=w) openings. The distance between the grid electrode 26 and the photoconductor drum 1 was fixed at 1.5 mm. The grid electrode 26 was connected to a negative terminal of the high-voltage power supply 27 so as to apply a given voltage. The current flow through the grid electrode 26 (grid current) was measured with an ammeter A2.

Furthermore, a surface potential measuring probe 30 was provided 90° downstream from the negative ion production element 20a with respect to the rotational direction of the photoconductor drum 1 so as to measure the surface potential of the photoconductor drum 1. The surface potential measuring probe 30 was mounted to a stage (not shown) which could scan the photoconductor drum 1 along its length so as to draw a surface potential profile not only along the periphery of the photoconductor drum 1, but also along the length. The surface potential meter used was TereK's Model 344. The photoconductor drum 1 was rotated at 124 mm/s. In addition, ion production, ozone production, etc. were measured similarly to experiment 1. The current flow through the photoconductor drum 1 was measured with an ammeter A3.

Experimental conditions included the following: gap g=20 mm; the applied voltage to the negative ion production element 20a was 7.7 kV (Va=−7.7 kV); and the applied voltage to the grid electrode 26 was 900 V (Vg=−900 V). Experiment was conducted with and without the fixed resistor 24 being inserted.

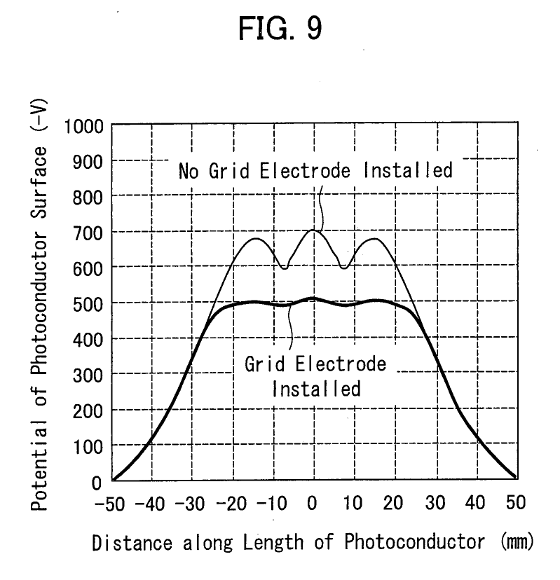

FIG. 9 is a graph showing results of the experiment. The graph represents the surface potential profile of the photoconductor drum 1 with the grid electrode 26 and that without the grid electrode 26, both taken along the length of the photoconductor drum 1, for comparison. Table 1 shows measurements of the negative ion production and the ozone production. In FIG. 9, distances along the length of the photoconductor drum 1 were plotted on the horizontal axis, and the surface potentials of the photoconductor drum 1 were plotted on the vertical axis. The three ion generation needles 21 were positioned parallel to the length of the photoconductor drum 1 so that the middle needle was located right above the midpoint of the photoconductor drum 1 to which the distances were referenced.

TABLE 1

| | Produced Negative Ions | Produced Ozone |
|---|---|---|
| | (Number of Ions/cc) | Density (ppm) |
| No Grid Installed | 18,000,000 | 0.002 |
| Grid Installed | 18,000,000 | 0.003 |

As shown in FIG. 9, the surface of the photoconductor drum 1 was charged with and without the grid electrode 26. Also, as shown in Table 1, a sufficient quantity of negative ions was produced (18,000,000 ions/cc), and almost no ozone was produced (in other words, a very small quantity of ozone (0.002 ppm to 0.003 ppm) was produced). If corona discharge had occurred, ozone would have been produced in a large quantity. The fact that the experiment produced little ozone (a very small quantity of ozone) confirmed that it was not corona discharge, but negative ions, that contributed to the charging of the photoconductor drum 1 in the experiment. The negative ions were able to sufficiently charge the photoconductor drum 1.

In addition, as shown in FIG. 9, when there was no grid electrode 26, the surface potential showed fluctuations (three peaks) corresponding to the positions of the three ion generation needles 21. When the grid electrode 26 was there, the potential showed smaller fluctuations. These results confirm that the provision of the grid electrode 26 restrains the fluctuations of the surface potential and improves the controllability of the surface potential.

Experiment 3

Next, using the experimental device shown in FIG. 8, relationship was examined among the applied voltage to the negative ion production element 20a (the absolute value of the potential difference Va relative to ground potential), the surface potential, V₀, of the photoconductor drum 1, the net current It, and the ozone production. Experimental conditions included the following: gap g=10 mm; the distance separating the grid electrode 26 from the photoconductor drum 1 was fixed at 1.5 mm; and the applied voltage to the grid electrode 26 was 700 V (Vg=−700 V). Measurement was conducted with and without the fixed resistor 24 being inserted.

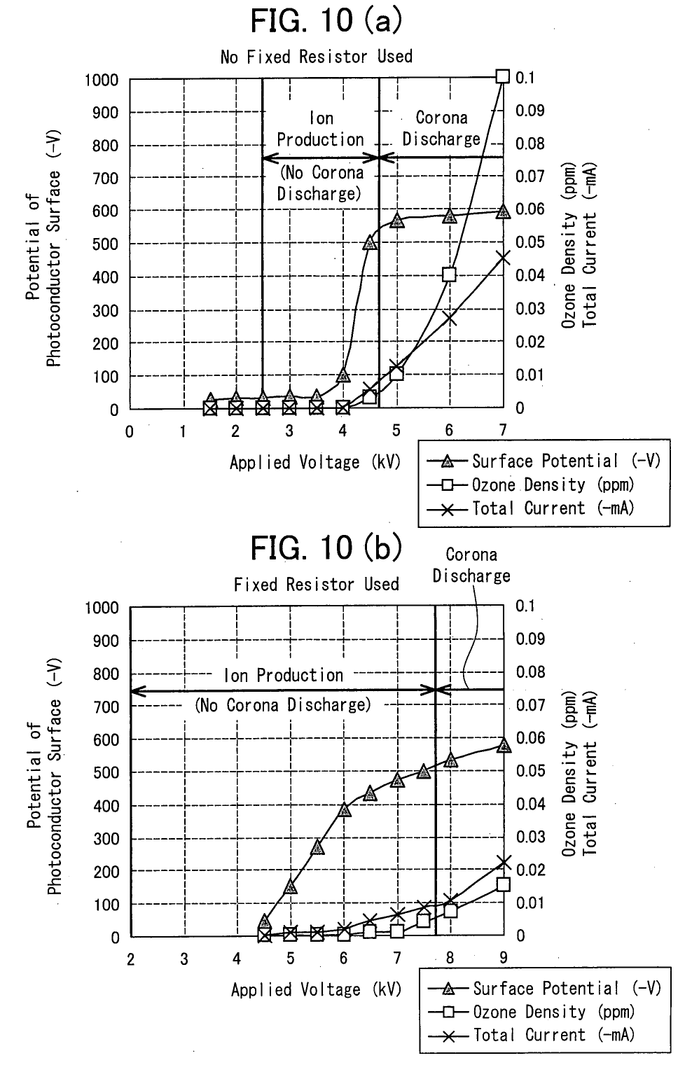

FIG. 10(a) is a graph showing results of the measurement without the fixed resistor 24 being inserted. FIG. 10(b) is a graph showing results of the measurement with the fixed resistor 24 being inserted.

Referring to FIG. 10(a), as the applied voltage to the negative ion production element 20a was gradually increased, the surface of the photoconductor drum 1 started being charged around 3.75 kV (Va=−3.75 kV; “charge threshold voltage”). The applied voltage was further increased, and the absolute value of the surface potential V₀ increased with the increasing applied voltage. In addition, little ozone was produced (a very small quantity of ozone was produced) when the applied voltage was 5 kV or lower (Va≧−5 kV). Above 5 kV (Va<−5 kV), the ozone production and the net current It suddenly increased with the increasing applied voltage.

The facts that the ion production threshold voltage was 2.5 kV (see FIG. 6(a)) without the fixed resistor 24 and that the ozone production suddenly increased at or above 5 kV indicate that the drum 1 was charged by negative ionic discharge when the applied voltage was 3.75 kV or higher and less than 5 kV (−3.75 kV≧Va>−5 kV) and by corona discharge, as well as by ion production, when the applied voltage was 0.5 kV or higher (Va≦−5 kV).

With the fixed resistor 24 being inserted as shown in FIG. 10(b), the charge threshold voltage was 4.5 kV (Va=−4.5 kV), and the corona discharge threshold voltage was 7.5 kV (Va=−7.5 kV). Both values were higher than those measured when no fixed resistor 24 was inserted, for the following reason. Voltage drop occurred across the fixed resistor 24, and the charge threshold voltage and the corona discharge threshold voltage had to be compensated for that voltage drop. Almost no current flowed in experiment 2. In contrast, current flowed to the grid electrode 26 and the photoconductor drum 1 in this experiment, which lead to the voltage drop across the fixed resistor 24.

As can be seen from FIG. 10(a) and FIG. 10(b), the “shift” of the charge threshold voltage (difference due to the insertion/lack of the fixed resistor 24) was smaller than the shift of the corona discharge threshold voltage. As a result, the range of the applied voltage in which the drum 1 could be charged only by ion production was only 1.0 kV (−3.75 kV≧Vₐ>−4.75 kV) when no fixed resistor 24 was inserted, but as broad as 3.25 kV (−4.5≧Vₐ>−7.75 kV) when the fixed resistor 24 was inserted.

This was presumably due to the following reason. As shown in FIG. 10(a) and FIG. 10(b), the net current It was small (a few microamperes), which meant a small voltage drop (a few hundred volts) happening across the fixed resistor 24, while the drum was being charged only through ion production. Meanwhile, when corona discharge also took place, the net current It suddenly increased to a few dozen microamperes, which meant a large voltage drop (a few kilovolts) happening across the fixed resistor 24.

Experiment 4

Next, conditions under which only ion production occurred and corona discharge accompanied were examined using the experimental device shown in FIG. 8. In the examination, the applied voltage Va to the negative ion production element 20a and the gap g between the ion generation needles 21 and the photoconductor drum 1 were taken as parameters. Experimental conditions included the following: the applied voltage to the grid electrode 26 was 700 V (Vg=−700 V). Measurement was conducted with and without the fixed resistor 24 being inserted.

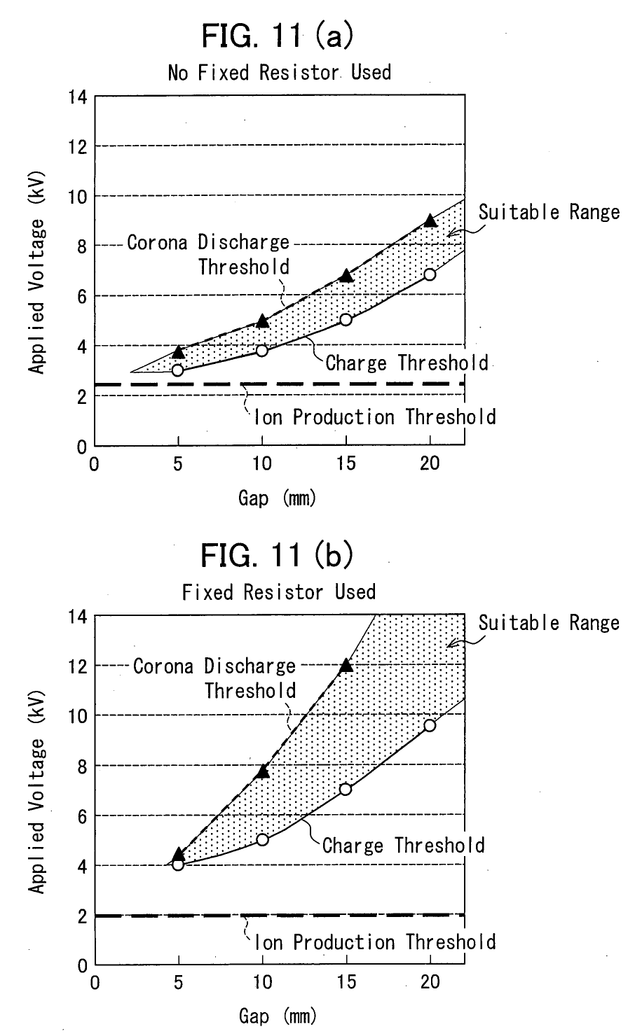

FIG. 11(a) is a graph showing results of the measurement without the fixed resistor 24 being inserted. FIG. 11(b) is a graph showing results of the measurement with the fixed resistor 24 being inserted.

As can be seen from FIG. 11(a) and FIG. 11(b), when the gap g was less than 4 mm, the drum 1 could not be charged only by ion production at any applied voltages (there was substantially no difference between the charge threshold voltage and the corona discharge threshold voltage). As the applied voltage was increased, corona discharge started immediately. If the gap g was 4 mm or greater, the drum 1 could be charged only by ion production within a certain range of the applied voltage. With the increasing gap g, the range of the applied voltage within which the drum 1 could be charged only by ion production (suitable range) broadened. The suitable range was broader when the fixed resistor 24 was inserted than when it was not.

These experimental results indicate that the gap g should be at least 4 mm to charge by ion production without causing corona discharge. The results of experiment 1 (see FIG. 7) show that the quantity (density) of negative ions that reached the photoconductor drum 1 decreased with increase in the gap g: when the gap g was in excess of 25 mm, negative ions reached the drum 1 in a quantity half or less that at gap g=5 mm. Accordingly, the gap g is preferably from 4 mm to 25 mm inclusive to suitably charge the photoconductor drum 1.

Incidentally, in the conventional charging device of a corona discharge type that uses needle-shaped electrodes disclosed in above-mentioned Tokukaihei 8-160711, the gap g is less than or equal to 4 mm for the purpose of reducing discharge current. The device provides no range of applied voltage in which only ion production occurs; corona discharge always occurs. Thus, Tokukaihei 8-160711 is less effective in reducing ozone production than the present invention.

Experiment 5

Next, experiment was conducted using the charging device 10 shown in FIG. 3 and FIG. 4, to measure the surface potential of the photoconductor drum 1 and ozone production, with the gap g varied from 3 mm to 30 mm. Experiment was conducted with and without the shield 23 being provided in place. The shield was made of an insulating ABS resin and allowed to float. Table 2 shows results of the measurement. The surface potential and the quantity of ozone were measured by the same devices and methods as in the foregoing experiments.

TABLE 2

| | | Applied | Grid | | Surface | Ozone | |
|---|---|---|---|---|---|---|---|
| | Gap g | Voltage | Voltage | Shield | Potential | Density | |
| Comp. Ex. 1-1 | 3 mm | −4 kV | −900 V | Not Used | −600 V | 0.09 | ppm |
| Ex. 1-1 | 4 mm | −4 kV | −900 V | Not Used | −605 V | 0.002 | ppm |
| Ex. 1-2 | 10 mm | −6.5 kV | −900 V | Not Used | −602 V | 0.001 | ppm |
| Ex. 1-3 | 25 mm | −12 kV | −900 V | Not Used | −600 V | ≈0 | ppm |
| Ex. 1-4 | 30 mm | −15 kV | −900 V | Used | −595 V | ≈0 | ppm |
| Comp. Ex. 1-2 | 30 mm | −15 kV | −900 V | Not Used | −425 V | ≈0 | ppm |

* Comp. Ex. < Comparative Example
* Ex. < Example

As can be seen from Table 2, as much as 0.09 ppm of ozone was produced at gap g=3 mm (comparative example 1-1). In contrast, setting the gap g to 4 mm or greater (examples 1-1 to 1-4) greatly reduced ozone production to less than or equal to 0.002 ppm for the following reason. Under no conditions, can the drum 1 be charged only by ion production when the gap g is less than or equal to 3 mm; the drum 1 has to be charged by corona discharge. Meanwhile, when the gap g is more than or equal to 4 mm, there exist conditions under which the photoconductor drum 1 can be charged only by ion production.

With no shield, the photoconductor drum 1 was charged to a surface potential of −600 V, which was the target value, at 4 mm≦g≦25 mm (examples 1-1 to 1-3). In the charging, the applied voltage was more than or equal to 4 kV and less than or equal to 12 kV (−4 kV≧Vₐ≧−12 kV). Note however that at gap g=30 mm (comparative example 1-2), the surface potential of the photoconductor drum 1 reached only −425 V (lower than the targeted −600 V) even when the applied voltage was increased to 1.5 kV (Va=−15 kV). This is due to the large gap g allowing negative ions to scatter and reach the photoconductor drum 1 in lower density.

In contrast, with the shield 23 provided (example 1-4), the photoconductor drum 1 was charged substantially as intended under an applied voltage of 15 kV (Va=−15 kV) even at gap g=30 mm. This is due to the shield 23 restricting negative ions from scattering, which in turn increases the density of negative ions near the photoconductor drum 1 and improves negative ion use efficiency.

As described in the foregoing, the charging device 10 of the present embodiment applies a voltage that is higher than or equal to the ion production threshold voltage and lower than the corona discharge threshold voltage to the charging electrodes (ion generation needles 21) to produce negative ions so that the negative ions can charge the charge-target object (photoconductor drum 1).

Therefore, unlike conventional scorotron chargers and other like charging devices of corona discharge types, no corona discharge occurs. The charge-target object is charged with the production of ozone, nitrogen oxide, and other discharge byproducts being reduced to a minimum. In conventional charging devices of corona discharge types, the discharge byproducts stick to the discharge electrode. Since no discharge occurs in the charging device of the present embodiment, there is no such concern that discharge byproducts could stick to the charging electrode.

The corona discharge threshold voltage can vary depending on the distance (gap) between the charging electrode and the charge-target object. Therefore, for example, the distance between the charging electrode and the charge-target object may be set to a predetermined value, and the applied voltage to the charging electrode to a value greater than or equal to the ion production threshold voltage and lower than the corona discharge threshold voltage. Alternatively, the applied voltage may be set to a value greater than or equal to the ion production threshold voltage, and the distance between the charging electrode and the charge-target object to a value greater than the corona discharge threshold distance.

However, if the distance between the charging electrode and the charge-target object is too short, the corona discharge threshold voltage decreases, moving closer to the charge threshold voltage. That makes it difficult to charge the charge-target object only with ions without causing any discharge. On the other hand, if the distance between the charging electrode and the charge-target object is too long, the quantity (density) of ions in the proximity of the charge-target object decreases, failing to suitably charge the charge-target object. Therefore, to suitably charge the charge-target object with ions without causing any accompanying corona discharge, the distance between the charging electrode and the charge-target object is preferably set to a value at which the charge-target object can be charged by ions produced by applying voltage to the charging electrode and which is greater than the corona discharge threshold distance. For example, the distance between the charging electrode and the charge-target object is preferably set to 4 mm to 25 mm inclusive.

In the present embodiment, there is inserted a resistor (fixed resistor 24) between the charging electrode and the voltage application means (high-voltage power supply 25) for applying the voltage to the charging electrode. The insertion of the resistor broadens the range of the applied voltage in which the charge-target object can be charged only by ion production without causing any accompanying corona discharge (ion production range), thereby enabling stable discharge of ions. Having said that, the resistor is not necessarily inserted; it may be omitted. The resistance of the resistor is not limited in any particular manner, and can be suitably specified so that the insertion can broaden the range of applied voltage at which the charge-target object can be charged only by ion production without causing any accompanying corona discharge and thereby enables stable discharge of ions.

In the present embodiment, there is provided a control electrode (grid electrode 26) between the charging electrode and the charge-target object. The control electrode provided between the charging electrode and the charge-target object collects excess ions and enables ions to be discharged at the charge-target object in a uniform quantity. The provision of the control electrode thus reduces charge irregularity along the length of the charging electrode caused by the pitches between charging electrodes and enables more suitable control of the surface potential of the charge-target object. Nevertheless, the charging device of the present invention is not limited to the structure that contains the control electrode; the control electrode may be omitted.

In the present embodiment, there is provided an ion scattering prevention member (shield 23) for the prevention of ions from scattering around the charging electrode. The ions produced by the application of voltage to the charging electrode move along electric lines of force toward the charge-target object. The electric field created is, however, weak when compared to the conventional charging device of a corona discharge type. Not all produced ions are discharged toward the charge-target object; some ions scatter in other directions. Accordingly, the provision of the ion scattering prevention member around the charging electrode prevents the scattering of ions, thereby improving ion use efficiency, and at the same time restrains those members disposed around the charging device from being unnecessarily charged.

In the present embodiment, there are used needle-shaped electrodes (ion generation needles 21) as the charging electrode. Therefore, a strong electric field can be produced at low voltage when compared to wire or sawtooth electrodes acting as the discharge electrode that are found in conventionally typical corona-discharge-based charging devices. Accordingly, ions are produced in large quantities at an applied voltage that is lower than the corona discharge threshold voltage.

In the present embodiment, there are used the needle-shaped ion generation needles 21 with sharp tips (sharp-tipped) shown in FIG. 3 and FIG. 4 as the charging electrode. This is by no means intended to be limiting the invention.

For example, any electrode may be used which has a conical, pyramidal, frustum, or similarly shaped sharp tip. These sharp-tipped electrodes experience a strong bending moment acting at the base. The base however has a greater diameter (or cross-sectional area) than the tip and provides improved mechanical strength to the electrode. In addition, the sharpness of the tip (small tip curvature radius) enables the production of strong electric field near the tip at low voltage and thus efficient production of ions. In addition, the added distance from the electrode support member (or the base of the electrode) to the tip prevents charging characteristics from deteriorating due to electrical interference from the electrode support member (or the base of the electrode).

Alternatively, a sawtoothed (sharp-tipped) electrode (sawtooth electrode) may be used. When this is the case, the sawtooth has sharp tips and therefore is capable of producing strong electric field at low voltage similarly to the needle, conical, pyramidal, and frustum electrodes. It is easier to reduce the tip curvature radius, and thus create stronger electric field at lower voltage, with the needle, conical, pyramidal, and frustum electrodes than with the sawtooth electrode. In addition, sawtooth electrodes are readily fabricable by photoetching or electrocasting. Also, sawtooth electrodes exhibit excellent mechanical strength.

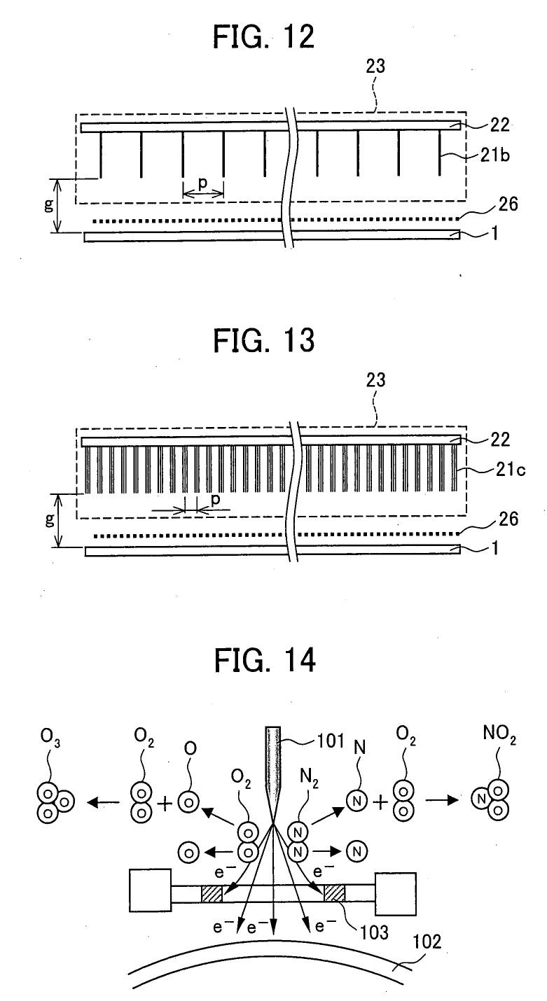

A further alternative is linear (ultrathin line) charging electrodes (linear electrodes 21b) as shown in FIG. 12 as an example. The structure shown in FIG. 12 is substantially the same as the structure shown in FIG. 3 and FIG. 4 except for the charging electrode. Here, no description is given of the common portion of the structure.

The structure in FIG. 12 contains multiple (here, 32) linear electrodes 21b disposed on a metal (here, stainless steel) base frame 22 at a predetermined pitch p. Each linear electrode 21b is either a tungsten wire or a stainless steel wire 70 μm in diameter, and has a tip facing the photoconductor drum 1. The pitch p between the linear electrodes 21b is 10 mm.

The photoconductor drum 1 was charged using the charging device 10 shown in FIG. 12. Conditions included the following: the applied voltage to the linear electrodes 21b was 6.5 kV (Va=−6.5 kV); the applied voltage to the grid electrode 26 was 900 V (Vg=−900 V); and gap g=10 mm. The surface of the photoconductor drum 1 was charged to −600 V.

As detailed above, the use of the linear electrodes 21b produced negative ions similarly to the use of the ion generation needles 21 shown in FIG. 3 and FIG. 4. In other words, the linear electrodes 21b are capable of producing stronger electric field at lower voltage than the wire and sawtooth electrodes and thus large quantities of ions at or below the corona discharge threshold voltage, similarly to the needle, conical, pyramidal, and frustum charging electrodes. In addition, similarly to the needle, conical, pyramidal, frustum, and like charging electrodes, the distance from the electrode support member (or base) to the tip of the electrode increases if the linear charging electrode is used. The extra distance prevents charging characteristics from deteriorating due to electrical interference from the electrode support member (or base). The linear electrode does not have so sharp a tip (so small a tip curvature radius) as the needle, conical, pyramidal, and frustum electrodes; therefore, the latter are capable of producing stronger electric field at lower voltage and thus more efficiently producing ions. In addition, the linear charging electrode is fabricable more readily and inexpensively compared to the needle, conical, pyramidal, frustum, and like charging electrodes. In contrast, it is more difficult to secure mechanical strength with the linear electrode than with than the conical, pyramidal, frustum, and like charging electrodes. In addition, the linear electrode is given an increased diameter or cross-sectional area to secure sufficient mechanical strength, the extra tip diameter or cross-sectional area causes a decrease in electric field intensity; it is therefore easier to increase the ion-producing application voltage with the linear electrode than with the needle, conical, pyramidal, frustum, and like charging electrodes.

Other examples of the shape of the electrode include a cylinder, bar, and stepped cylinder (consisting of cylindrical portions with different cross-sectional areas being stacked up from the base to the tip). Other shapes are also possible. These electrodes provide similar advantages to those available with the linear electrode.

The charging electrode may also be like a brush. That is, the charging electrode may be made of bundles of fiber-like (for example, needle-shaped or linear) members. FIG. 13 is a side view of the charging device 10 in which brush-like charging electrodes (brush-like electrodes 21c) are used. Apart from the charging electrodes, the structure is substantially the same as the structure shown in FIG. 3 and FIG. 4; no description is given of the common portion of the structure.

In the structure in FIG. 13, the brush-like electrodes 21c are disposed on a metal (here, aluminum) base frame 22. Each brush-like electrodes 21c is a bundle of about 15 stainless steel fibers each measuring 12 μm in diameter. In the structure in FIG. 13, a plurality of brush-like electrodes 21c, each being such a bundle, are disposed at a predetermined pitch p. The pitch p between adjacent brush-like electrodes 21c is 1.6 mm in the structure in FIG. 13. Each brush-like electrode 21c (fiber-like component member of each brush-like electrode 21c) has a tip facing the photoconductor drum 1.

The photoconductor drum 1 was charged using the charging device 10 shown in FIG. 13. Conditions included the following: the applied voltage to the brush-like electrodes 21c was 9 kV (Va=−9 kV); the applied voltage to the grid electrode 26 was 900 V (Vg=−900 V); and gap g=10 mm. The surface of the photoconductor drum 1 was charged to −600 V.

The use of the brush-like electrodes as the charging electrode produced negative ions, although those electrodes did not show as high ion production efficiency as the ion generation needles 21 shown in FIG. 3 and FIG. 4. The brush-like electrodes 21c may, for example, have a similar structure to conventional discharge brushes used to remove static electricity from the surface of a photoconductor and be fabricable at lower cost than the needle-shaped and linear charging electrodes. The brush-like electrodes 21c reduce charge irregularity caused by the pitches between the charging electrodes when compared to the needle-shaped charging electrodes (ion generation needles 21) or linear charging electrode (linear electrodes 21b) detailed earlier, because each brush-like electrode 21c contains far more fibers (ion generation needles or ultrathin lines). If the charge-target object is a rotatable object, charge irregularity is further reduced. In addition, the brush-like electrodes 21c, even if dust or a like foreign object attaches to the tips, exhibit less negative effect on charging uniformity.

In the present embodiment, the charging electrode is the tungsten ion generation needles 21. The charging electrode may be made of other materials. For example, metals, such as stainless steel, may be used.

Carbon nanomaterials, such as carbon nanotubes, are well known to produce large quantities of ions at low voltage. The carbon nanomaterial is less preferred than tungsten, stainless steel, and like metals for the following reasons.

The first problem is that the carbon nanomaterial has very low durability and is not suitable for practical applications. If the carbon nanomaterial is used as an electrode material, the carbon nanomaterial wears out much faster than tungsten, stainless steel, and like metals when the material is subjected to voltage to produce ions in air. That requires frequent exchange of the electrodes, which is not practical.

The second problem is that the carbon nanomaterial has a very fine structure: each fiber is 1 nm to a few dozen nanometers in diameter. If dust, oil film, or water film attaches even in a very small quantity, it covers the nanomaterial and inhibits stable charging operation. This is especially so when charging a charge-target object in an electrophotographic apparatus, because the electrophotographic apparatus contains in it various kinds of dust including silicone oil from the fuser section, hydrophobic surface processing agent for the hydrophobic silica covering toner particles, wax, and scattered toner. The charging electrode is likely to electrostatically adsorb these kinds of dust. In addition, water vapor or a like gas, which could come from recording paper in fusing, may condense and attach as water film to the surface of the carbon nanomaterial. Also, oil may come from various components and attach in film form to the surface of the carbon nanomaterial. In contrast, when stainless steel, tungsten, or like electrode material is used, the charging characteristics of these materials could deteriorate due to attachment of dust, oil film, or water film, but the materials are far more tolerant to the attachment of these materials than the carbon nanomaterial.

The third problem is that the carbon nanomaterial is far more difficult to process than tungsten, stainless steel, and like metals. Therefore, the carbon nanomaterial is far more difficult to fabricate into the above-mentioned shapes (needle, conical, pyramidal, frustum, sawtoothed, linear, cylindrical, bar, stepped cylindrical, brush, etc.) than tungsten, stainless steel, and like metals. The carbon nanomaterial does not therefore exhibit the above-mentioned advantages. In addition, it is difficult to secure suitable adhesion strength to a support member with the carbon nanomaterial. It is therefore difficult to uniformly charge across the target area.

Therefore, the charging electrode is preferably made of tungsten, stainless steel, or a like metal than the carbon nanomaterial.

In the present embodiment, the photoconductor drum 1 is provided separately from the charging device 10. However, the photoconductor drum 1 and the charging device 10 can be regarded collectively as the charging device in accordance with an embodiment of the present invention.

In the present embodiment, the charging device is described as a device which charges the photoconductor in an electrophotographic image forming apparatus. The charging device may be used to charge something other than the photoconductor.

### Embodiment 2

Another embodiment of the present invention will be described. Here, for convenience, members of the present embodiment that have the same arrangement and function as members of embodiment 1, and that are mentioned in that embodiment are indicated by the same reference numerals and description thereof is omitted.

The present embodiment views the present invention from a different perspective than embodiment 1. The charge device 10 of the present embodiment has the same configuration as the charge device 10 of embodiment 1. In addition, the shape, material, etc of the component members (e.g., ion generation needles 21) of the charge device 10 may be modified similar to embodiment 1.

Embodiment 2 differs from embodiment 1 in that the settings of the range of voltage applied to the ion generation needles 21. Specifically, in embodiment 1, the voltage applied to the ion generation needles 21 is set to a value greater than or equal to the ion production threshold voltage and lower than the corona discharge threshold voltage. In contrast, in the present embodiment, the voltage applied to the ion generation needles 21 is set to either one of two values: one is higher than or equal to the ion production threshold voltage and lower than an ozone production surge threshold voltage (voltage at which ozone starts to be produced in a suddenly increasing quantity), and the other is higher than or equal to the ion production threshold voltage and lower than a total-current surge threshold voltage (voltage at which the net current (summed currents through the ion generation needles 21) starts sudden increases).

The ozone production surge threshold voltage, where no fixed resistor 24 is inserted between the ion generation needles 21 and the high-voltage power supply 25, is defined as a voltage at which the rate of increase of ozone production to an applied voltage reaches a maximum rate of change in a range from an ozone production threshold voltage, inclusive, to twice the ozone production threshold voltage, inclusive. The ozone production threshold voltage is defined as a voltage at which ozone starts to be produced as the voltage applied to the ion generation needles 21 is being increased by a predetermined value at a time. “No fixed resistor 24 being inserted between the ion generation needles 21 and the high-voltage power supply 25” means either complete absence of the fixed resistor 24 or, if present, its resistance being so low that the effect of the resistance on the ozone production surge threshold voltage is ignorable. As an example, if a single resistor 24 is inserted and N ion generation needles 21 are provided, the resistance, R, of the resistor 24 should be less than 50/N MΩ. If the rate of change at the ozone production threshold voltage is greater than or equal to twice the average of the rate of change over a range from the ozone production threshold voltage, exclusive, to twice the ozone production threshold voltage, inclusive, the ozone production surge threshold voltage is defined as the ozone production threshold voltage plus the predetermined value mentioned above. Also, if the rate of change at the ozone production threshold voltage is less than twice the average of the rate of change over that range, the ozone production surge threshold voltage is defined as equal to the ozone production threshold voltage.

Where the fixed resistor 24 is inserted between the ion generation needles 21 and the high-voltage power supply 25, the ozone production surge threshold voltage is defined as a voltage at which the rate of increase of ozone production to an applied voltage reaches a local maximum rate of change in a range from the ozone production threshold voltage, exclusive, to twice the ozone production threshold voltage, inclusive. The ozone production threshold voltage is defined as a voltage at which ozone starts to be produced as the voltage applied to the ion generation needles 21 is being increased by a predetermined value at a time. “The fixed resistor 24 being inserted between the ion generation needles 21 and the high-voltage power supply 25” means its resistance being such that the effect of the resistance on the ozone production surge threshold voltage is not ignorable. As an example, if a single resistor 24 is inserted and N ion generation needles 21 are provided, the resistance, R, of the resistor 24 should be such that 50/N MΩ≦R≦2000/N MΩ.

The total-current surge threshold voltage (current surge threshold voltage), where no fixed resistor 24 is inserted between the ion generation needles 21 and the high-voltage power supply 25, is defined as a voltage at which the rate of increase of a current flow through the ion generation needles 21 to an applied voltage reaches a maximum rate of change in a range from a current occurrence threshold voltage, inclusive, to twice the current occurrence threshold voltage, inclusive. The current occurrence threshold voltage is defined as a voltage at which an electric current starts to flow through the ion generation needles 21 as the voltage applied to the ion generation needles 21 is being increased by a predetermined value at a time. “No fixed resistor 24 being inserted between the ion generation needles 21 and the high-voltage power supply 25” means either complete absence of the fixed resistor 24 or, if present, its resistance being so low that the effect of the resistance on the total-current surge threshold voltage is ignorable. As an example, if a single resistor 24 is inserted and N ion generation needles 21 are provided, the resistance, R, of the resistor 24 should be less than 50/N MΩ. If the rate of change at the current occurrence threshold voltage is greater than or equal to twice the average of the rate of change over a range from the current occurrence threshold voltage, exclusive, to twice the current occurrence threshold voltage, inclusive, the total-current surge threshold voltage is defined as the current occurrence threshold voltage plus the predetermined value mentioned above. Also, if the rate of change at the current occurrence threshold voltage is less than twice the average of the rate of change over that range, the total-current surge threshold voltage is defined as equal to the current occurrence threshold voltage.

Where the fixed resistor 24 is inserted between the ion generation needles 21 and the high-voltage power supply 25, the total-current surge threshold voltage is defined as a voltage at which the rate of increase of ozone production to an applied voltage reaches a local maximum rate of change in a range from the current occurrence threshold voltage, exclusive, to twice the current occurrence threshold voltage, inclusive. The current occurrence threshold voltage is defined as a voltage at which an electric current starts to flow through the ion generation needles 21 as the voltage applied to the ion generation needles 21 is being increased by a predetermined value at a time. “The fixed resistor 24 being inserted between the ion generation needles 21 and the high-voltage power supply 25” means its resistance being such that the effect of the resistance on the total-current surge threshold voltage is not ignorable. As an example, if a single resistor 24 is inserted and N ion generation needles 21 are provided, the resistance, R, of the resistor 24 should be such that 50/N MΩ≦R≦2000/N MΩ.

If the ozone production or the net current varies every time a voltage is applied, measurement is repeated (desirably, 16 times or more) for an average value.

Now, the effect of setting the voltage applied to the ion generation needles 21 as above will be described in reference to experimental results. The results of experiments 1 to 5 presented below are identical to those of experiments 1 to 5 in embodiment 1.

Experiment 1

First, a negative ion production element 20a shown in FIG. 5 was prepared.

The negative ion production element 20a had multiple (here, 3) needle-shaped ion generation needles 21 fixed on a metal (here, stainless steel) base frame 22. Each ion generation needle 21 was 99.999% tungsten and 1 mm in diameter. The needle 21 had a conical portion with a taper angle of 34° and a curvature radius of 15 μm at the tip. Adjacent ion generation needles 21 were separated by a pitch of 10 mm.

The negative ion production element 20a was placed in a free space 1 m in radius in which there was nothing but an air inlet (detailed later). Negative ion production, ozone production, and electric current were measured upon voltage application in two cases: (1) the negative ion production element 20a was connected to a negative terminal of the high-voltage power supply 25; and (2) the negative ion production element 20a was connected to the negative terminal of the high-voltage power supply 25 via the fixed resistor 24 (resistance=200 MΩ). In other words, in one case, there was the fixed resistor 24 (resistance=200 MΩ) between the negative ion production element 20a and the high-voltage power supply 25. In the other, there was none. As additional information, the high-voltage power supply 25 was Trek Inc.'s Model 610C. Also, a negative ion meter AIC-2000 available from Sato Shoji Corporation and an ozone monitor EG2002F available from Ebara Jitsugyo Co., Ltd. were used. Negative ion production was measured 150 mm away from the ion generation needles 21 five seconds after the voltage application to the ion generation needles 21 was started. Ozone production was measured by providing the air inlet 10 mm away from the ion generation needles 21. The measurement was obtained as an average over 12 measurement cycles (12 cycles×15 seconds/cycle=180 seconds or 3 minutes) after the voltage application to the ion generation needles 21 was started.

FIG. 6(a) is a graph showing experimental results in the case of no fixed resistor 24 being inserted. FIG. 6(b) is a graph showing experimental results in the case of the fixed resistor 24 being inserted.

FIG. 6(a), showing the case of no fixed resistor 24 being inserted, indicates that negative ion production started (negative ionic measurement started to rise) when the applied voltage exceeded 2.5 kV (i.e., when Va≦−2.5 kV). FIG. 6(b), showing the case of the fixed resistor 24 being inserted, indicates that negative ion production started when the applied voltage exceeded 2 kV (i.e., when Va≦−2.0 kV). In both cases, the quantity of negative ion production (quantity of ions produced) suddenly increased with increase in the applied voltage (increase in the absolute value of the potential difference Va relative to ground potential) and reached saturation at about 1×10⁷ ions/cc. Also in both cases, almost no ozone was produced. Ozone production dropped by large quantities when compared with the conventional charging device of a corona discharge type.

These results demonstrate that high voltage application to the needle-shaped negative ion production element 20a shown in FIG. 5 with no discharge destination object in the surroundings produces a large quantity of negative ions with almost no ozone being produced (that is, ozone production being reduced by large quantities).

The negative ion production threshold voltage was somewhat lower when the fixed resistor 24 was inserted than when it was not, presumably for the following reasons. The ions are produced by difference in potential between air and the ion generation needles 21 with the air acting as a virtual positive electrode. Since the impedance of the air is very unstable, ion production becomes unstable in a region where the ion production starts at low applied voltage if no fixed resistor 24 is provided. The insertion of the fixed resistor 24 stabilizes the overall impedance inclusive of that of the air, which in turn stabilizes the ion production.

Next, the fixed resistor 24 was inserted, and the applied voltage was set to 3 kV (Va=−3 kV). Under these conditions, the quantity (density) of negative ions was measured in relation with a distance L from the ion generation needles 21. FIG. 7 is a graphical representation of results. The quantity of negative ions is shown in relative values for L>5 mm, taking the quantity of negative ions when L=5 mm to be 100%.

As can be seen from the figure, the density of negative ions decreased with increasing L. Also from FIG. 7, at least 50% the quantity (density) of negative ions when L=5 mm is secured so long as L≦25 mm.

Experiment 2

Next, a charging characteristic was measured by experiment on the photoconductor drum 1 using the negative ion production element 20a. First, the experimental device will be described in reference to FIG. 8.

The photoconductor drum 1 was an organic photoconductor (OPC) 30 mm in diameter and 30 μm in film thickness (the photoconductor drum used in a color copying machine manufactured by Sharp Kabushiki Kaisha (product name “MX-2300”)). The drum 1 was so mounted that it could rotate at a given rotation speed. The negative ion production element 20a was placed at a predetermined gap g away from the drum 1. The photoconductor drum 1 and the negative ion production element 20a were so placed in a sealed acrylic enclosure measuring 40 cm wide by 25 cm high by 80 cm long that the negative ion production element 20a could be positioned at the center of the enclosure. The negative ion production element 20a was mounted to a stage (not shown) which could be moved parallel to the length of the photoconductor so that the gap g could be set to any value from 0 to 30 mm. The current flow through the negative ion production element 20a (net current) was measured with an ammeter A1.

Between the photoconductor drum 1 and the ion generation needles 21 of the negative ion production element 20a was provided a 0.1-mm thick, stainless steel grid electrode 26 used in AR-625S manufactured by Sharp Kabushiki Kaisha. The electrode 26 had 26-mm wide (=w) openings. The distance between the grid electrode 26 and the photoconductor drum 1 was fixed at 1.5 mm. The grid electrode 26 was connected to a negative terminal of the high-voltage power supply 27 so as to apply a given voltage. The current flow through the grid electrode 26 (grid current) was measured with an ammeter A2.

Furthermore, a surface potential measuring probe 30 was provided 90° downstream from the negative ion production element 20a with respect to the rotational direction of the photoconductor drum 1 so as to measure the surface potential of the photoconductor drum 1. The surface potential measuring probe 30 was mounted to a stage (not shown) which could scan the photoconductor drum 1 along its length so as to draw a surface potential profile not only along the periphery of the photoconductor drum 1, but also along the length. The surface potential meter used was TereK's Model 344. The photoconductor drum 1 was rotated at 124 mm/s. In addition, ion production, ozone production, etc. were measured similarly to experiment 1. The current flow through the photoconductor drum 1 was measured with an ammeter A3.

Experimental conditions included the following: gap g=20 mm; the applied voltage to the negative ion production element 20a was 7.7 kV (Va=−7.7 kV); and the applied voltage to the grid electrode 26 was 900 V (Vg=−900 V). Experiment was conducted with and without the fixed resistor 24 being inserted.

FIG. 9 is a graph showing results of the experiment. The graph represents the surface potential profile of the photoconductor drum 1 with the grid electrode 26 and that without the grid electrode 26, both taken along the length of the photoconductor drum 1, for comparison. Table 3 shows measurements of the negative ion production and the ozone production. In FIG. 9, distances along the length of the photoconductor drum 1 were plotted on the horizontal axis, and the surface potentials of the photoconductor drum 1 were plotted on the vertical axis. The three ion generation needles 21 were positioned parallel to the length of the photoconductor drum 1 so that the middle needle was located right above the midpoint of the photoconductor drum 1 to which the distances were referenced.

TABLE 3

| | Produced Negative Ions | Produced Ozone |
|---|---|---|
| | (Number of Ions/cc) | Density (ppm) |
| No Grid Installed | 18,000,000 | 0.002 |
| Grid Installed | 18,000,000 | 0.003 |

As shown in FIG. 9, the surface of the photoconductor drum 1 was charged with and without the grid electrode 26. Also, as shown in Table 3, a sufficient quantity of negative ions was produced (18,000,000 ions/cc), and almost no ozone was produced (in other words, a very small quantity of ozone (0.002 ppm to 0.003 ppm) was produced). If corona discharge had occurred, ozone would have been produced in a large quantity. The fact that the experiment produced little ozone (a very small quantity of ozone) confirmed that it was not corona discharge, but negative ions, that contributed to the charging of the photoconductor drum 1 in the experiment. The negative ions were able to sufficiently charge the photoconductor drum 1.

In addition, as shown in FIG. 9, when there was no grid electrode 26, the surface potential showed fluctuations (three peaks) corresponding to the positions of the three ion generation needles 21. When the grid electrode 26 was there, the potential showed smaller fluctuations. These results confirm that the provision of the grid electrode 26 restrains the fluctuations of the surface potential and improves the controllability of the surface potential.

Experiment 3

Next, using the experimental device shown in FIG. 8, relationship was examined among the applied voltage to the negative ion production element 20a (the absolute value of the potential difference Va relative to ground potential), the surface potential, V₀, of the photoconductor drum 1, the net current It, and the ozone production. Experimental conditions included the following: gap g=10 mm; the distance separating the grid electrode 26 from the photoconductor drum 1 was fixed at 1.5 mm; and the applied voltage to the grid electrode 26 was 700 V (Vg=−700 V). Measurement was conducted with and without the fixed resistor 24 being inserted. In addition, the applied voltage was increased from 0 V by 500 V at a time to examine relationship among the surface potential, V₀, of the photoconductor drum 1, the net current It, and ozone production at each applied voltage.

FIG. 10(a) is a graph showing results of measurement without the fixed resistor 24 being inserted. FIG. 10(b) is a graph showing results of the measurement with the fixed resistor 24 being inserted.

Referring to FIG. 10(a), as the applied voltage to the negative ion production element 20a was gradually increased, the surface of the photoconductor drum 1 started being charged around 3.75 kV (Va=−3.75 kV; “charge threshold voltage”). The applied voltage was further increased, and the absolute value of the surface potential V₀ increased with the increasing applied voltage.

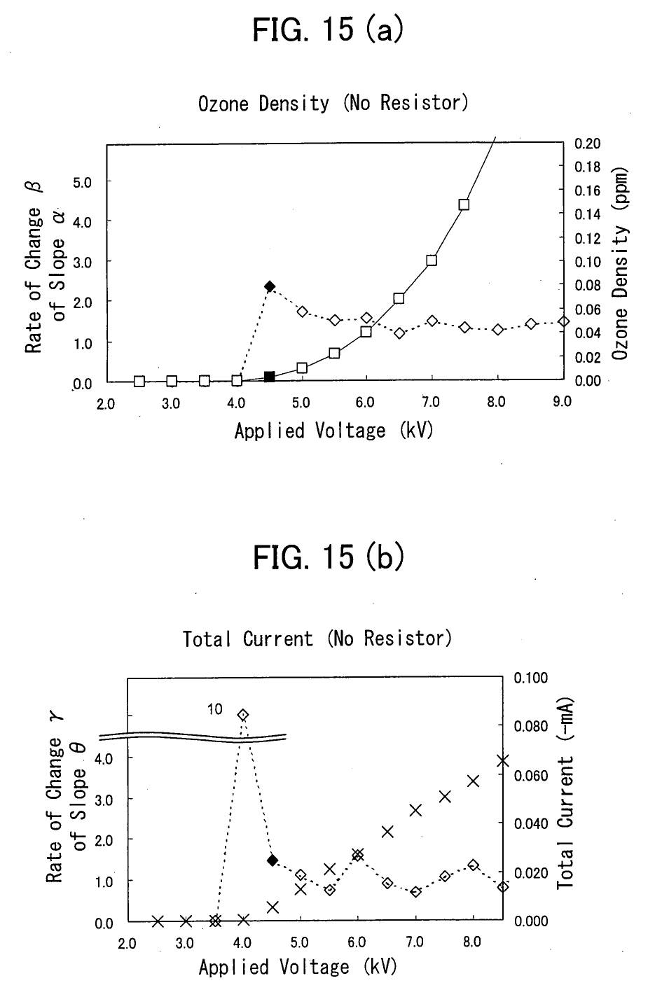

FIG. 15(a) is a graph showing relationship between the applied voltage and the ozone production shown in FIG. 10(a), as well as the rate β of change of increase α in the ozone production to increase in the applied voltage.

The rate of increase α of the ozone production O to the applied voltage V at a measurement point n is given by αₙ=(Oₙ−Oₙ₋₁)/(Vₙ−Vₙ₋₁). The rate β of change of the rate of increase α of the ozone production to the applied voltage is given by βₙ=αₙ₊₁/αₙ. If the calculation of the rate β of change involves division by zero, β=0. The value of the measurement point n is increased by 1 every time the applied voltage is increased by 500 V. The measurement was continued until the applied voltage reached twice the ozone production threshold voltage. The ozone production threshold voltage is the applied voltage at a measurement point at which ozone is first detected (or ozone starts to be produced) when the applied voltage is increased.

In the present embodiment, the ozone production surge threshold voltage, where no fixed resistor 24 is inserted between the ion generation needles 21 and the high-voltage power supply 25, is defined as a voltage at which the rate of increase of ozone production to an applied voltage reaches a maximum rate of change in a range from an ozone production threshold voltage, inclusive, to twice the ozone production threshold voltage, inclusive. The ozone production threshold voltage is defined as a voltage at which ozone starts to be produced as the voltage applied to the ion generation needles 21 is being increased by a predetermined value at a time. If the rate of change at the ozone production threshold voltage is greater than or equal to twice the average of the rate of change over a range from the ozone production threshold voltage, exclusive, to twice the ozone production threshold voltage, inclusive, the ozone production surge threshold voltage is defined as the ozone production threshold voltage plus the predetermined value mentioned above. Therefore, the experimental results give an ozone production surge threshold voltage of 4.5 kV (Va=−4.5 kV), as shown in FIG. 15(a), which equals the ozone production threshold voltage.

FIG. 15(a) demonstrates that the charge-target object is charged by ions with limited production of ozone if the applied voltage Va to the negative ion production element 20a is higher than or equal to the charge threshold voltage (here, 3.75 kV) and lower than the ozone production surge threshold voltage (here, 4.5 kV).

FIG. 15(b) is a graph showing relationship between the applied voltage and the net current shown in FIG. 10(a), as well as the rate γ of change of increase θ in the net current to increase in the applied voltage.

The rate of increase θ of the net current It to the applied voltage V at a measurement point m is given by θₘ=(Itₘ−Itₘ₋₁)/(Vₘ−Vₘ₋₁). The rate γ of change of the rate of increase θ of the net current It to the applied voltage V is given by γₘ=θₘ₊₁/θₘ. If the calculation of the rate γ of change involves division by zero, γ=0. The value of the measurement point m is increased by 1 every time the applied voltage is increased by 500 V. The measurement was continued until the applied voltage reached twice the current occurrence threshold voltage. The current occurrence threshold voltage is the applied voltage at a measurement point at which net current is first detected when the applied voltage is increased.

In the present embodiment, the total-current surge threshold voltage, where no fixed resistor 24 is inserted between the ion generation needles 21 and the high-voltage power supply 25, is defined as a voltage at which the rate of increase of a current flow through the ion generation needles 21 to an applied voltage reaches a maximum rate of change in a range from a current occurrence threshold voltage, inclusive, to twice the current occurrence threshold voltage, inclusive. The current occurrence threshold voltage is defined as a voltage at which an electric current starts to flow through the ion generation needles 21 as the voltage applied to the ion generation needles 21 is being increased by a predetermined value at a time. If the rate of change at the current occurrence threshold voltage is greater than or equal to twice the average of the rate of change over a range from the current occurrence threshold voltage, exclusive, to twice the current occurrence threshold voltage, inclusive, the total-current surge threshold voltage is defined as the current occurrence threshold voltage plus the predetermined value mentioned above.

Therefore, the experimental results give a total-current surge threshold voltage of 4.5 kV (Va=−4.5 kV), as shown in FIG. 15(b), which equals the current occurrence threshold voltage.

FIG. 15(b) demonstrates that the charge-target object is charged by ions with limited increase in the net current if the applied voltage Va to the negative ion production element 20a is higher than or equal to the charge threshold voltage (here, 3.75 kV) and lower than the total-current surge threshold voltage (here, 4.5 kV). Also, FIG. 15(a) demonstrates that the charge-target object is charged by ions with limited production of ozone if the applied voltage Va to the negative ion production element 20a is higher than or equal to the charge threshold voltage (here, 3.75 kV) and lower than the total-current surge threshold voltage (here, 4.5 kV).

In contrast, referring to FIG. 10(b), when the fixed resistor 24 is inserted, the charge threshold voltage was 4.5 kV (Va=−4.5 kV). As the applied voltage was further increased, the absolute value of the surface potential V₀ increased with the applied voltage.

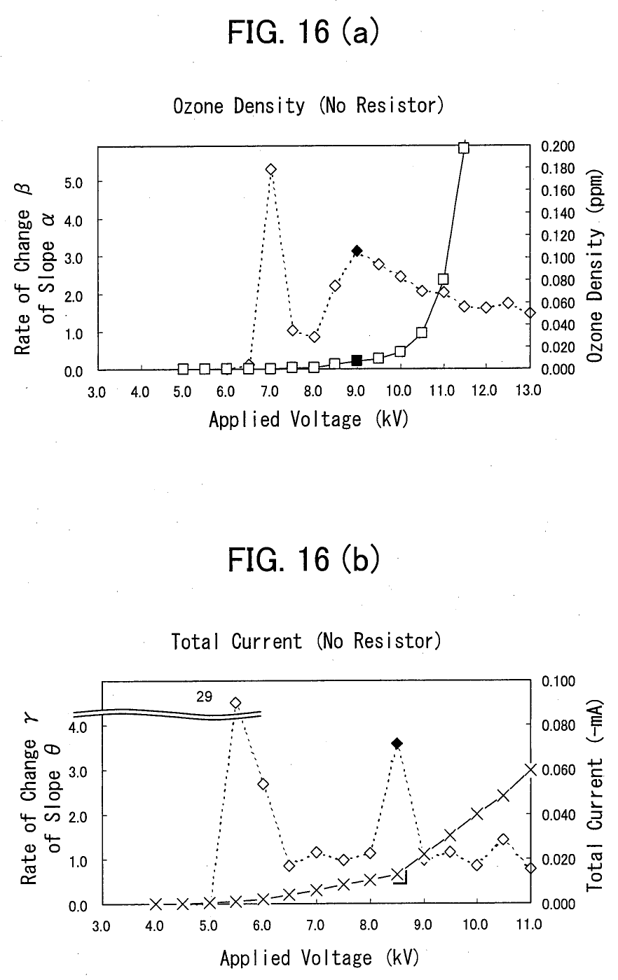

FIG. 16(a) is a graph showing relationship between the applied voltage and the ozone production shown in FIG. 10(b), as well as the rate β of change of increase a in the ozone production to increase in the applied voltage.

In the present embodiment, the ozone production surge threshold voltage, where the fixed resistor 24 is inserted between the ion generation needles 21 and the high-voltage power supply 25, is defined as a voltage at which the rate of increase of ozone production to an applied voltage reaches a local maximum rate of change in a range from the ozone production threshold voltage, exclusive, to twice the ozone production threshold voltage, inclusive. The ozone production threshold voltage is defined as a voltage at which ozone starts to be produced as the voltage applied to the ion generation needles 21 is being increased by a predetermined value at a time. Therefore, the experimental results give an ozone production surge threshold voltage of 9.0 kV (Va=−9.0 kV), as shown in FIG. 16(a).

FIG. 16(a) demonstrates that even when the resistance is inserted, the charge-target object is charged by ions with limited production of ozone if the applied voltage Va to the negative ion production element 20a is higher than or equal to the charge threshold voltage (here, 4.5 kV) and lower than the ozone production surge threshold voltage (here, 9.0 kV).

FIG. 16(b) is a graph showing relationship between the applied voltage and the net current shown in FIG. 10(b), as well as the rate γ of change of increase θ in the net current to increase in the applied voltage.

The total-current surge threshold voltage, where the fixed resistor 24 is inserted between the ion generation needles 21 and the high-voltage power supply 25, is defined as a voltage at which the rate of increase of ozone production to an applied voltage reaches a local maximum rate of change in a range from the current occurrence threshold voltage, exclusive, to twice the current occurrence threshold voltage, inclusive. The current occurrence threshold voltage is defined as a voltage at which an electric current starts to flow through the ion generation needles 21 as the voltage applied to the ion generation needles 21 is being increased by a predetermined value at a time. Therefore, the experimental results give an ozone production surge threshold voltage of 8.5 kV (Va=−8.5 kV) as shown in FIG. 16(b).

FIG. 16(b) demonstrates that the charge-target object is charged by ions with limited increase in the net current if the applied voltage Va to the negative ion production element 20a is higher than or equal to the charge threshold voltage (here, 4.5 kV) and lower than the total-current surge threshold voltage (here, 8.5 kV). Also, FIG. 16(a) demonstrates that the charge-target object is charged by ions with limited production of ozone if the applied voltage Va to the negative ion production element 20a is higher than or equal to the charge threshold voltage (here, 4.5 kV) and lower than the total-current surge threshold voltage (here, 8.5 kV).

As described above, both the ozone production surge threshold voltage and the total-current surge threshold voltage were higher when the fixed resistor 24 was inserted then when it was not. The increases in the threshold voltages are due to the voltage drop occurring across the fixed resistor 24. The charge threshold voltage, the ozone production surge threshold voltage, and the total-current surge threshold voltage increase by an amount equivalent to the voltage drop. There was almost no current flow in experiment 2. On the other hand, there is a current flow through the grid electrode 26 and the photoconductor drum 1 in this experiment; therefore, there emerges effect of the voltage drop across the fixed resistor 24.

FIGS. 10(a) and 10(b) indicate that the ozone production surge threshold voltage and the total-current surge threshold voltage exhibited greater shifts (difference between when the fixed resistor 24 was inserted and when it was not) than did the charge threshold voltage. As a result, the range of the applied voltage in which the object was charged without causing sudden increase in the ozone production grew from 0.75 kV (−3.75 kV≧Vₐ>−4.5 kV; when no fixed resistor 24 was inserted) to 4.5 kV (−4.5≧Vₐ>−9.0 kV; when the fixed resistor 24 was inserted). Similarly, the range of applied voltage in which the target was charged without causing sudden increase in the net current grew from 2.25 kV (−3.75 kV≧Vₐ>−4.5 kV; when no fixed resistor 24 was inserted) to 4.0 kV (−4.5≧Vₐ>−8.5 kV; when the fixed resistor 24 was inserted).

These phenomena occurred presumably due to the following reasons. As shown in FIGS. 10(a) and 10(b), when the applied voltage is low, the net current It is small (a few microamperes), which in turn causes a small voltage drop (a few hundred volts) across the fixed resistor 24. As the applied voltage is increased, the net current It suddenly increases (a few tens of microamperes), which in turn causes a large voltage drop (a few kilovolts) across fixed resistor 24.

The ozone production surge threshold voltage and the total-current surge threshold voltage differed between when the fixed resistor 24 was inserted and when it was not, presumably for the following reasons.

The net current and the ozone production are largely dependent on the electric field intensity between the ion generation needles 21 and the photoconductor drum 1. That electric field intensity is in proportion to the voltage between the ion generation needles 21 and the photoconductor drum 1 and in inverse proportion to the distance between the ion generation needles 21 and the photoconductor drum 1.

With the fixed resistor 24 being inserted, the net current starts to flow at applied voltage=5.5 kV. The net current and the ozone production increase in proportion to the applied voltage under restrictions, such as the spatial impedance between the ion generation needles 21 and the photoconductor drum 1 and the inserted fixed resistor 24 (first proportional increase). When the applied voltage exceeds an inflection point at which the ozone production increases abruptly, the spatial impedance changes by the effect of the ozone. The net current and the ozone production now increase in proportion to the applied voltage with different proportionality factors from the first proportional increase (second proportional increase). Therefore, the rates β, γ of change at that inflection point provide the local maxima.

In contrast, with no fixed resistor 24 being inserted, the net current starts to flow at applied voltage=4.0 kV. Since there is no fixed resistor 24 causing a voltage drop, there is an inflection point near applied voltage=4.0 kV at which the net current and the ozone production increase abruptly. Therefore, no first proportional increase is observed in experimental results; only the second proportional increase is observed.

Therefore, in the present embodiment, if the rate β of change at the ozone production threshold voltage is greater than or equal to twice the average of the rate β of change over a range from the ozone production threshold voltage, exclusive, to twice the ozone production threshold voltage, inclusive, the ozone production surge threshold voltage is defined as the ozone production threshold voltage plus the predetermined value (the foregoing constant value by which the voltage applied to the ion generation needles 21 is gradually increased). Also, if the rate γ of change at the current occurrence threshold voltage is greater than or equal to twice the average of the rate γ of change over a range from the current occurrence threshold voltage, exclusive, to twice the current occurrence threshold voltage, inclusive, the current surge threshold voltage is defined as the from the current occurrence threshold voltage plus the predetermined value (the foregoing constant value by which the voltage applied to the ion generation needles 21 is gradually increased).

If the first proportional increase and the second proportional increase, and thus the inflection point, are appropriately identifiable with no fixed resistor 24 being inserted, the ozone production surge threshold voltage and the current surge threshold voltage may be defined the same way as they are defined when the fixed resistor 24 is inserted. the first proportional increase and the second proportional increase would be appropriately identifiable by, for example, setting the difference between the applied voltage values at the measurement points to a suitable value (for example, 250 V to 1000 V).

Experiment 4

Next, charging tests were conducted using the experimental device shown in FIG. 8. In the tests, the applied voltage Va to the negative ion production element 20a and the gap g between the ion generation needles 21 and the photoconductor drum 1 were taken as parameters. Experimental conditions included the following: the applied voltage to the grid electrode 26 was 700 V (Vg=−700 V). Measurement was conducted with and without the fixed resistor 24 being inserted.

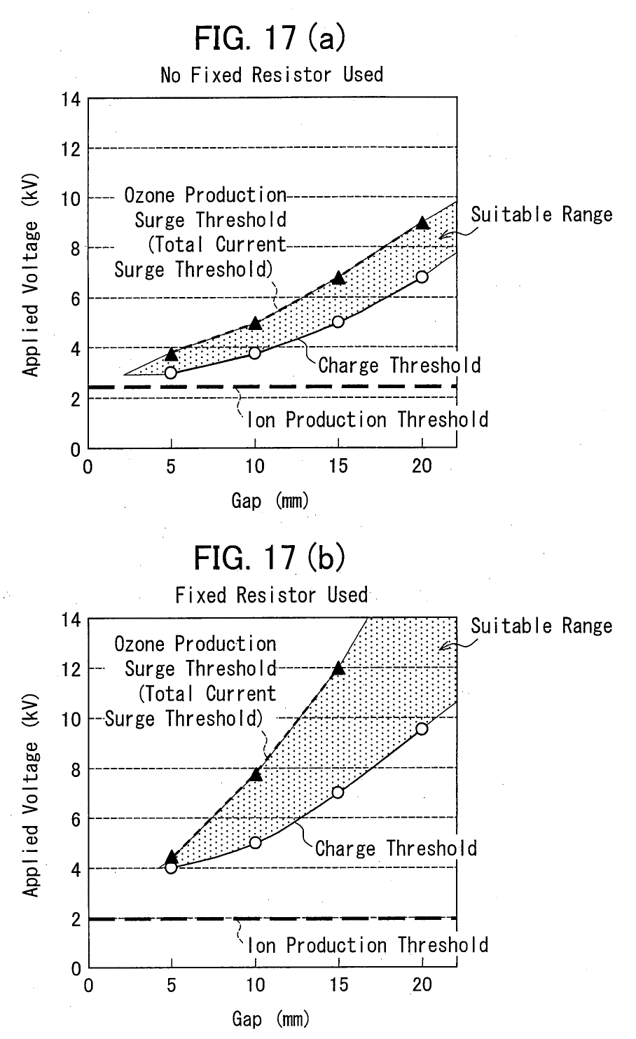

FIG. 17(a) is a graph showing results of the measurement without the fixed resistor 24 being inserted. FIG. 17(b) is a graph showing results of the measurement with the fixed resistor 24 being inserted.

As can be seen from FIG. 17(a) and FIG. 17(b), when the gap g was less than 4 mm, the drum 1 could not be charged without causing sudden increase in the ozone production or net current at any applied voltages (there was substantially no difference between the charge threshold voltage and the ozone production surge threshold voltage or between the charge threshold voltage and the total current surge threshold voltage). As the applied voltage was increased, the ozone production and the net current suddenly increased. In contrast, if the gap g was 4 mm or greater, the drum 1 could be charged only by ions within a certain range of the applied voltage; the drum 1 could be charged without causing sudden increase in the ozone production or the net current. With the increasing gap g, the range of the applied voltage within which the drum 1 could be charged by ions without causing sudden increase in the ozone production or the net current (suitable range) broadened. The suitable range was broader when the fixed resistor 24 was inserted than it was not.

These experimental results indicate that the gap g should be at least 4 mm to charge by ions without causing sudden increase in the ozone production. The results of experiment 1 (see FIG. 7) show that the quantity (density) of negative ions that reached the photoconductor drum 1 decreased with increase in the gap g: when the gap g was in excess of 25 mm, negative ions reached the drum 1 in a quantity half or less that at gap g=5 mm. Accordingly, the gap g is preferably from 4 mm to 25 mm inclusive to suitably charge the photoconductor drum 1.

Incidentally, in the conventional charging device of a corona discharge type that uses needle-shaped electrodes disclosed in above-mentioned Tokukaihei 8-160711, the gap g is less than or equal to 4 mm for the purpose of reducing discharge current. The device provides no range of applied voltage in which ion production occurs primarily. the ozone production and the net current show sudden increase. Thus, Tokukaihei 8-160711 provides less effective in reducing ozone production than the present invention.

Experiment 5

Next, experiment was conducted using the charging device 10 shown in FIG. 3 and FIG. 4, to measure the surface potential of the photoconductor drum 1 and ozone production, with the gap g varied from 3 mm to 30 mm. Experiment was conducted with and without the shield 23 being provided in place. The shield was made of an insulating ABS resin and allowed to float. Table 4 shows results of the measurement. The surface potential and the quantity of ozone were measured by the same devices and methods as in the foregoing experiments.

TABLE 4

| | | Applied | Grid | | Surface | Ozone | |
|---|---|---|---|---|---|---|---|
| | Gap g | Voltage | Voltage | Shield | Potential | Density | |
| Comp. Ex. 1-1 | 3 mm | −4 kV | −900 V | Not Used | −600 V | 0.09 | ppm |
| Ex. 1-1 | 4 mm | −4 kV | −900 V | Not Used | −605 V | 0.002 | ppm |
| Ex. 1-2 | 10 mm | −6.5 kV | −900 V | Not Used | −602 V | 0.001 | ppm |
| Ex. 1-3 | 25 mm | −12 kV | −900 V | Not Used | −600 V | ≈0 | ppm |
| Ex. 1-4 | 30 mm | −15 kV | −900 V | Used | −595 V | ≈0 | ppm |
| Comp. Ex. 1-2 | 30 mm | −15 kV | −900 V | Not Used | −425 V | ≈0 | ppm |

* Comp. Ex. < Comparative Example
* Ex. < Example

As can be seen from Table 4, as much as 0.09 ppm of ozone was produced at gap g=3 mm (comparative example 1-1). In contrast, setting the gap g to 4 mm or greater (examples 1-1 to 1-4) greatly reduced ozone production to less than or equal to 0.002 ppm for the following reason. Under no conditions, can the drum 1 be charged without causing sudden increase in the ozone production when the gap g is less than or equal to 3 mm; the drum 1 has to be charged by corona discharge. Meanwhile, when the gap g is more than or equal to 4 mm, there exist conditions under which the photoconductor drum 1 can be charged without causing sudden increase in the ozone production.

With no shield, the photoconductor drum 1 was charged to a surface potential of −600 V, which was the target value, at 4 mm≦g≦25 mm (examples 1-1 to 1-3). In the charging, the applied voltage was more than or equal to 4 kV and less than or equal to 12 kV (−4 kV≧Vₐ≧−12 kV). Note however that at gap g=30 mm (comparative example 1-2), the surface potential of the photoconductor drum 1 reached only −425 V (lower than the targeted −600 V) even when the applied voltage was increased to 15 kV (Va=−15 kV). This is due to the large gap g allowing negative ions to scatter and reach the photoconductor drum 1 in lower density.

In contrast, with the shield 23 provided (example 1-4), the photoconductor drum 1 was charged substantially as intended under an applied voltage of 15 kV (Va=−15 kV) even at gap g=30 mm. This is due to the shield 23 restricting negative ions from scattering, which in turn increases the density of negative ions near the photoconductor drum 1 and improves negative ion use efficiency.

As described in the foregoing, the charging device 10 of the present embodiment applies a voltage that is higher than or equal to the ion production threshold voltage and lower than the ozone production surge threshold voltage to the charging electrodes (ion generation needles 21) to produce negative ions so that the negative ions can charge the charge-target object (photoconductor drum 1).

Therefore, the device 10 reduces the production of ozone, nitrogen oxides, and other discharge byproducts in the charging of the charge-target object when compared with charging devices of a corona discharge type, such as a conventional scorotron charger. In conventional charging devices of corona discharge types, the discharge byproducts stick to the discharge electrode. This problem is addressed by the charging device of the present embodiment by reducing the quantity of discharge byproducts that stick to the charging electrode.

The ozone production surge threshold voltage can vary depending on the distance (gap) between the charging electrode and the charge-target object. Therefore, for example, the distance between the charging electrode and the charge-target object may be set to a predetermined value, and the applied voltage to the charging electrode to a value greater than or equal to the ion production threshold voltage and less than the ozone production surge threshold voltage. Alternatively, the applied voltage may be set to a predetermined value greater than or equal to the ion production threshold voltage, and the distance between the charging electrode and the charge-target object to a value less than the distance at which ozone starts suddenly increase (ozone production surge threshold distance). That is, the applied voltage may be set to a predetermined value greater than or equal to the ion production threshold voltage, and the distance between the charging electrode and the charge-target object may be set so that the predetermined value is less than the ozone production surge threshold voltage.

However, if the distance between the charging electrode and the charge-target object is too short, the ozone production surge threshold voltage decreases, and so does the difference between the charge threshold voltage and the ozone production surge threshold voltage. That makes it difficult to charge the charge-target object without causing sudden increase in the ozone production. On the other hand, if the distance between the charging electrode and the charge-target object too long, the quantity (density) of ions in the proximity of the charge-target object decreases, failing to suitably charging the charge-target object. Therefore, for example, the distance between the charging electrode and the charge-target object is preferably set to 4 mm to 25 mm inclusive.

The total-current surge threshold voltage can vary depending on the distance (gap) between the charging electrode and the charge-target object. Therefore, for example, the distance between the charging electrode and the charge-target object may be set to a predetermined value, and the applied voltage to the charging electrode to a value greater than or equal to the ion production threshold voltage and less than the total-current surge threshold voltage. Alternatively, the applied voltage may be set to a predetermined value greater than or equal to the ion production threshold voltage, and the distance between the charging electrode and the charge-target object to a value less than the distance at which the net current shows sudden increase (total-current surge threshold distance). That is, the applied voltage may be set to a predetermined value greater than or equal to the ion production threshold voltage and so that the predetermined value is less than the total-current surge threshold voltage.

However, if the distance between the charging electrode and the charge-target object is too short, the total-current surge threshold voltage decreases, and so does the difference between the charge threshold voltage and the total-current surge threshold voltage. That makes it difficult to charge the charge-target object without causing sudden increase in the net current. On the other hand, if the distance between the charging electrode and the charge-target object is too long, the quantity (density) of ions in the proximity of the charge-target object decreases, failing to suitably charging the charge-target object. Therefore, for example, the distance between the charging electrode and the charge-target object is preferably set to 4 mm to 25 mm inclusive.

The charging device 10 of the present embodiment is not limited to the structure explained above. The device may be modified as in embodiment 1.

The present invention is applicable to any charging device that either charges or discharges a charge-target object in a non-contact manner. Examples of such applications include those charging devices which charge a photoconductor or like charge-target object, transfer units (charging devices) which electrostatically transfer a toner image on, for example, a photoconductor to, for example, recording paper, and paper removal units (charging devices) which peel off, for example, recording paper that is electrostatically sticking to, for example, a photoconductor.

As described in the foregoing, a charging device of the present invention is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; and the voltage application means applies to the charging electrode a voltage higher than or equal to an ion production threshold voltage and lower than a corona discharge threshold voltage.

According to the arrangement, ions are produced by applying a voltage higher than or equal to an ion production threshold voltage to the charging electrode. The charge-target object is thus charged by the ions produced. In addition, since the voltage applied to the charging electrode is less than a corona discharge threshold voltage, no corona discharge occurs. The charge-target object is thus charged with ozone, NOₓ, etc. being produced in very small quantities. In addition, since no corona discharge accompanies, no discharge byproducts stick to the electrode and no electrode tip is corroded or degraded due to discharge energy as in the conventional charging device of a corona discharge type. Stable charging over time is thus achieved. Furthermore, since a weaker electric field is generated than in the conventional charging device of a corona discharge type, not all ions produced are discharged toward the charge-target object: the distribution of the quantity of ions produced is somewhat broad near the charge-target object. Charging uniformity is improved over the conventional charging device of a corona discharge type.

Another charging device of the present invention is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; the voltage application means applies to the charging electrode a voltage higher than or equal to an ion production threshold voltage; and the charging electrode is separated from the charge-target object by such a distance that the charge-target object can be charged by ions produced by the voltage applied to the charging electrode, the distance being greater than a corona discharge threshold distance.

According to the arrangement, ions are produced by applying a voltage higher than or equal to an ion production threshold voltage to the charging electrode. The charge-target object is thus charged by the ions produced. In addition, since the distance between the charging electrode and the charge-target object is greater than a corona discharge threshold distance, no corona discharge occurs. The charge-target object is thus charged with ozone, NOₓ, etc. being produced in very small quantities. In addition, since no corona discharge accompanies, no discharge byproducts stick to the electrode and no electrode tip is corroded or degraded due to discharge energy as in the conventional charging device of a corona discharge type. Stable charging over time is thus achieved. Furthermore, since a weaker electric field is generated than in the conventional charging device of a corona discharge type, not all ions produced are discharged toward the charge-target object: the ions are scattered before reaching the charge-target object. Furthermore, the distance between the charging electrode and the charge-target object is greater than in the conventional charging device of a corona discharge type. Charging uniformity is thus improved over the conventional charging device of a corona discharge type.

Another charging device of the present invention is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; and the voltage application means applies to the charging electrode a voltage higher than or equal to an ion production threshold voltage and less than an ozone production surge threshold voltage at which ozone starts to be produced in a suddenly increasing quantity.

According to the arrangement, ions are produced by applying a voltage higher than or equal to an ion production threshold voltage to the charging electrode. The charge-target object is thus charged by the ions produced. In addition, since the voltage applied to the charging electrode is less than an ozone production surge threshold voltage, the charge-target object is charged with ozone being produced in a very small quantity.

Another charging device of the present invention is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; the voltage application means applies to the charging electrode a voltage higher than or equal to an ion production threshold voltage; and the charging electrode is separated from the charge-target object by such a distance that the charge-target object can be charged by ions produced by the voltage applied to the charging electrode, the distance being greater than an ozone production surge threshold distance at which ozone starts to be produced in a suddenly increasing quantity.

According to the arrangement, ions are produced by applying a voltage higher than or equal to an ion production threshold voltage to the charging electrode. The charge-target object is thus charged by the ions produced. In addition, since the distance between the charging electrode and the charge-target object is greater than an ozone production surge threshold distance, the charge-target object is charged with ozone being produced in a very small quantity.

The ozone production surge threshold distance may be such a distance that the voltage which the voltage application means applies to the charging electrode equals an ozone production surge threshold voltage at which ozone starts to be produced in a suddenly increasing quantity.

The ozone production surge threshold voltage may be: where there is inserted no resistor between the charging electrode and the voltage application means, a voltage at which a rate of increase of ozone production to an applied voltage reaches a maximum rate of change in a range from an ozone production threshold voltage, inclusive, to twice the ozone production threshold voltage, inclusive, the ozone production threshold voltage being a voltage at which ozone starts to be produced as the voltage applied to the charging electrode is being increased by a predetermined value at a time (if the rate of change at the ozone production threshold voltage is greater than or equal to twice the average of the rate of change over a range from the ozone production threshold voltage, exclusive, to twice the ozone production threshold voltage, inclusive, the ozone production surge threshold voltage equals the ozone production threshold voltage plus the predetermined value); and where there is inserted a resistor between the charging electrode and the voltage application means, a voltage at which a rate of increase of ozone production to an applied voltage reaches a local maximum rate of change in a range from the ozone production threshold voltage, exclusive, to twice the ozone production threshold voltage, inclusive, the ozone production threshold voltage being a voltage at which ozone starts to be produced as the voltage applied to the charging electrode is being increased by a predetermined value at a time.

Another charging device of the present invention is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; and the voltage application means applies to the charging electrode a voltage higher than or equal to an ion production threshold voltage and less than a current surge threshold voltage at which an electric current which the voltage application means supplies to the charging electrode starts to suddenly increase.

According to the arrangement, ions are produced by applying a voltage higher than or equal to an ion production threshold voltage to the charging electrode. The charge-target object is thus charged by the ions produced. In addition, since the voltage applied to the charging electrode is less than a current surge threshold voltage, the charge-target object is charged with limited increase in the current flow through the charging electrode. Power consumption can be thus lowered. Furthermore, according to the arrangement, the voltage applied to the charging electrode is lower than in the conventional charging device of a corona discharge type. Ozone production is thus reduced.

Another charging device of the present invention is characterized in that it includes: a charging electrode positioned so as not to contact a charge-target object provided inside an electrophotographic apparatus; and voltage application means for applying voltage to the charging electrode, wherein: the charge-target object is charged by applying voltage to the charging electrode; the voltage application means applies to the charging electrode a voltage higher than or equal to an ion production threshold voltage; and the charging electrode is separated from the charge-target object by such a distance that the charge-target object can be charged by ions produced by the voltage applied to the charging electrode, the distance being greater than a current surge threshold distance at which an electric current which the voltage application means supplies to the charging electrode starts to suddenly increase.

According to the arrangement, ions are produced by applying a voltage higher than or equal to an ion production threshold voltage to the charging electrode. The charge-target object is thus charged by the ions produced. In addition, since the distance between the charging electrode and the charge-target object is less than a current surge threshold distance, the charge-target object is charged with limited increase in the current flow through the charging electrode. Power consumption can be thus lowered. Furthermore, according to the arrangement, the voltage applied to the charging electrode is lower than in the conventional charging device of a corona discharge type. Ozone production is thus reduced.

The current surge threshold distance may be such a distance that the voltage which the voltage application means applies to the charging electrode equals a current surge threshold voltage at which a current flow through the charging electrode starts to suddenly increase.

The current surge threshold voltage may be: where there is inserted no resistor between the charging electrode and the voltage application means, a voltage at which a rate of increase of current flow through the charging electrode to an applied voltage reaches a maximum rate of change in a range from a current occurrence threshold voltage, inclusive, to twice the current occurrence threshold voltage, inclusive, the current occurrence threshold voltage being a voltage at which electric current starts to flow through the charging electrode as the voltage applied to the charging electrode is being increased by a predetermined value at a time (if the rate of change at the current occurrence threshold voltage is greater than or equal to twice the average of the rate of change over a range from the current occurrence threshold voltage, exclusive, to twice the current occurrence threshold voltage, inclusive, the current surge threshold voltage equals the current occurrence threshold voltage plus the predetermined value); and where there is inserted a resistor between the charging electrode and the voltage application means, a voltage at which a rate of increase of current flow through the charging electrode to an applied voltage reaches a local maximum rate of change in a range from the current occurrence threshold voltage, exclusive, to twice the current occurrence threshold voltage, inclusive, the current occurrence threshold voltage being a voltage at which electric current starts to flow through the charging electrode as the voltage applied to the charging electrode is being increased by a predetermined value at a time.

Another charging device of the present invention is characterized in that it includes: a charging electrode positioned so as not to contact a charge-target object provided inside an electrophotographic apparatus; and voltage application means for applying voltage to the charging electrode, wherein: the charge-target object is charged by ions produced by applying to the charging electrode a voltage higher than or equal to an ion production threshold voltage and less than an ozone production surge threshold voltage at which ozone starts to be produced in a suddenly increasing quantity.

According to the arrangement, ions are produced by applying to the charging electrode a voltage higher than or equal to an ion production threshold voltage and less than an ozone production surge threshold voltage. The charge-target object is thus charged by the ions produced.

In any one of the foregoing arrangement, the charging electrode may be a plurality of needle-shaped or linear electrodes.

According to the arrangement, the charging electrodes are shaped like needles or linear. A strong electric field is generated at a low voltage when compared to wire or sawtooth electrodes provided in the conventionally common charging device of a corona discharge type. Therefore, ions are produced in large quantities under an applied voltage lower than the corona discharge threshold voltage. Hence, the charge-target object is charged efficiently.

In any one of the foregoing arrangement, the charging electrode may be a plurality of brush-like electrodes each being a plurality of needle-shaped or linear members.

According to the arrangement, the use of the brush-like charging electrodes reduces charge irregularity caused by the pitches of the charging electrodes. Charging uniformity is thus improved. In addition, even if dust or a like foreign object attaches to electrode tips, the charging uniformity is less affected.

In any one of the foregoing arrangement, the charging electrode may be separated from the charge-target object by a distance from 4 mm to 25 mm inclusive.

Since the distance between the charging electrode and the charge-target object is set to 4 mm or greater, ions are produced (discharged) at a lower applied voltage than the corona discharge threshold voltage. Meanwhile, the greater the distance between the charging electrode and the charge-target object, the less the quantity (density) of ions that reach the charge-target object. Therefore, if the distance is too great, the charge-target object cannot be efficiently charged. The setting of the distance to 25 mm or less enables the supply of ions in a sufficient quantity for the suitable charging of the charge-target object to the neighborhood of the charge-target object.

There may be further included a resistor inserted between the charging electrode and the voltage application means.

The insertion of a resistor between the charging electrode and the voltage application means increases the difference between the charge threshold voltage and the corona discharge threshold voltage. Therefore, the range of voltage in which the charge-target object can be charged by discharged ions without causing any accompanying corona discharge broadens. Stable charging is thus achieved.

There may be further included a control electrode, provided between the charging electrode and the charge-target object, for controlling quantity of ions passing.

The control electrode, provided between the charging electrode and the charge-target object, collects excess ions and enables ions to be discharged at the charge-target object in a uniform quantity. Charging uniformity is thus improved.

There may be further included an ion scattering prevention member, having an opening at least to the charge-target object, for limiting ion scattering, the member being positioned to enclose the charging electrode.

The ions produced by applying a voltage to the charging electrode move toward the charge-target object along electric lines of force. Nevertheless, since a weaker electric field is generated than in the conventional charging device of a corona discharge type, not all ions produced are discharged toward the charge-target object: some ions are scattered in directions other than the charge-target object. Accordingly, the provision of an ion scattering prevention member, having an opening to the charge-target object, which encloses the charging electrode, limits ion scattering improves ion use efficiency. In addition, those members disposed around the charging device are restrained from unnecessarily charged by the ions scattered.

The ion scattering prevention member preferably has a face facing the charging electrode, the face being made of either an insulating material or such a high resistance material that no corona discharge can occur between the face and the charging electrode.

According to the arrangement, the ion scattering prevention member has a face, facing the charging electrode, which is made of either an insulating material or a high resistance material. Therefore, even if the ion scattering prevention member is separated from the charging electrode by too short a distance, corona discharge is prevented from occurring between the charging electrode and the ion scattering prevention member.

An image forming apparatus of the present invention is characterized in that it is an electrophotographic image forming apparatus and includes any one of the foregoing charging devices for use in charging a photoconductor.

According to the arrangement, the photoconductor is charged with ozone, NOₓ, etc. being produced in very small quantities. In addition, since no corona discharge accompanies, no discharge byproducts stick to the electrode and no electrode tip is corroded or degraded due to discharge energy. Stable charging over time is thus achieved. Furthermore, since not all ions produced are discharged toward the charge-target object: the distribution of the quantity of ions produced is somewhat broad near the charge-target object. Charging uniformity is thus improved.

A method of charging of the present invention is characterized in that it is a method of charging a charge-target object provided inside an electrophotographic apparatus by applying voltage to a charging electrode positioned so as not to contact the charge-target object and also in that it involves the step of applying to the charging electrode a voltage higher than or equal to an ion production threshold voltage and lower than a corona discharge threshold voltage.

According to the method, ions are produced by applying a voltage higher than or equal to an ion production threshold voltage to the charging electrode. The charge-target object is thus charged by the ions produced. In addition, since the voltage applied to the charging electrode is less than a corona discharge threshold voltage, no corona discharge occurs. The charge-target object is thus charged with ozone, NOₓ, etc. being produced in very small quantities. In addition, since no corona discharge accompanies, no discharge byproducts stick to the electrode and no electrode tip is corroded or degraded due to discharge energy as in the conventional method of charging of a corona discharge type. Stable charging over time is thus achieved. Furthermore, since a weaker electric field is generated than in the conventional method of charging of a corona discharge type, not all ions produced are discharged toward the charge-target object: the distribution of the quantity of ions produced is somewhat broad near the charge-target object. Therefore, Charging uniformity is thus improved over the conventional method of charging of a corona discharge type.

Another method of charging of the present invention is characterized in that it is a method of charging a charge-target object provided inside an electrophotographic apparatus by applying voltage to a charging electrode positioned so as not to contact the charge-target object and also in that it involves the step of applying a voltage higher than or equal to an ion production threshold voltage to the charging electrode facing the charge-target object and separated from the charge-target object by a greater distance than a corona discharge threshold distance.

According to the method, ions are produced by applying a voltage higher than or equal to an ion production threshold voltage to the charging electrode. The charge-target object is thus charged by the ions produced. In addition, since the distance between the charging electrode and the charge-target object is greater than a corona discharge threshold distance, no corona discharge occurs. The charge-target object is thus charged with ozone, NOₓ, etc. being produced in very small quantities. In addition, since no corona discharge accompanies, no discharge byproducts stick to the electrode and no electrode tip is corroded or degraded due to discharge energy as in the conventional charging device of a corona discharge type. Stable charging over time is thus achieved. Furthermore, since a weaker electric field is generated than in the conventional charging device of a corona discharge type, not all ions produced are discharged toward the charge-target object: the ions are scattered before reaching the charge-target object. Furthermore, the distance between the charging electrode and the charge-target object is greater than in the conventional charging device of a corona discharge type. Charging uniformity is thus improved over the conventional charging device of a corona discharge type.

Another method of charging of the present invention is characterized in that it is a method of charging a charge-target object provided inside an electrophotographic apparatus by applying voltage to a charging electrode positioned so as not to contact the charge-target object and also in that it involves the step of applying to the charging electrode a voltage higher than or equal to an ion production threshold voltage and less than an ozone production surge threshold voltage at which ozone starts to be produced in a suddenly increasing quantity.

According to the method, ions are produced by applying a voltage higher than or equal to an ion production threshold voltage to the charging electrode. The charge-target object is thus charged by the ions produced. In addition, since the voltage applied to the charging electrode is less than an ozone production surge threshold voltage, the charge-target object is charged with ozone being produced in a very small quantity.

Another method of charging of the present invention is characterized in that it is a method of charging a charge-target object provided inside an electrophotographic apparatus by applying voltage to a charging electrode positioned so as not to contact the charge-target object and also in that it involves the step of applying a voltage higher than or equal to an ion production threshold voltage to the charging electrode facing the charge-target object and separated from the charge-target object by a greater distance than an ozone production surge threshold distance at which ozone starts to be produced in a suddenly increasing quantity.

According to the method, ions are produced by applying a voltage higher than or equal to an ion production threshold voltage to the charging electrode. The charge-target object is thus charged by the ions produced. In addition, since the distance between the charging electrode and the charge-target object is greater than an ozone production surge threshold distance, the charge-target object is charged with ozone being produced in a very small quantity.

Another method of charging of the present invention is characterized in that it is a method of charging a charge-target object by applying voltage to a charging electrode positioned so as not to contact the charge-target object and also in that it involves the step of applying to the charging electrode a voltage higher than or equal to an ion production threshold voltage and less than a current surge threshold voltage at which an electric current which the voltage application means supplies to the charging electrode starts to suddenly increase.

According to the method, ions are produced by applying a voltage higher than or equal to an ion production threshold voltage to the charging electrode. The charge-target object is thus charged by the ions produced. In addition, since the voltage applied to the charging electrode is less than a current surge threshold voltage, the charge-target object is charged with limited increase in the current flow through the charging electrode. Power consumption can be thus lowered. Furthermore, according to the method, the voltage applied to the charging electrode is lower than in the conventional charging device of a corona discharge type. Ozone production is thus reduced.

Another method of charging of the present invention is characterized in that it is a method of charging a charge-target object provided inside an electrophotographic apparatus by applying voltage to a charging electrode positioned so as not to contact the charge-target object and also in that it involves the step of applying a voltage higher than or equal to an ion production threshold voltage to the charging electrode facing the charge-target object and separated from the charge-target object by a greater distance than a current surge threshold distance at which an electric current which the voltage application means supplies to the charging electrode starts to suddenly increase.

According to the method, ions are produced by applying a voltage higher than or equal to an ion production threshold voltage to the charging electrode. The charge-target object is thus charged by the ions produced. In addition, since the distance between the charging electrode and the charge-target object is less than a current surge threshold distance, the charge-target object is charged with limited increase in the current flow through the charging electrode. Power consumption can be thus lowered. Furthermore, according to the method, the voltage applied to the charging electrode is lower than in the conventional charging device of a corona discharge type. Ozone production is thus reduced.

Another method of charging of the present invention is characterized in that it is a method of charging a charge-target object by applying voltage to a charging electrode, there being provided the charging electrode positioned so as not to contact the charge-target object provided inside an electrophotographic apparatus; and voltage application means for applying voltage to the charging electrode, and also in that it involves the step of charging the charge-target object by ions produced by applying to the charging electrode a voltage higher than or equal to an ion production threshold voltage and less than an ozone production surge threshold voltage at which ozone starts to be produced in a suddenly increasing quantity.

According to the method, ions are produced by applying to the charging electrode a voltage higher than or equal to an ion production threshold voltage and less than an ozone production surge threshold voltage. The charge-target object is thus charged by the ions produced.

The present invention is not limited to the description of the embodiments above, but may be altered by a skilled person within the scope of the claims. An embodiment based on a proper combination of technical means disclosed in different embodiments is encompassed in the technical scope of the present invention.

What is claimed:

1. A charging device, comprising:
a charging electrode positioned so as not to contact a charge-target object provided inside an electrophotographic apparatus; and
voltage application means for applying voltage to the charging electrode,
wherein:
the charge-target object is charged by applying voltage to the charging electrode; and
the voltage application means applies to the charging electrode a voltage higher than or equal to an ion production threshold voltage and lower than a corona discharge threshold voltage.

2. A charging device, comprising:
a charging electrode positioned so as not to contact a charge-target object provided inside an electrophotographic apparatus; and
voltage application means for applying voltage to the charging electrode,
wherein:
the charge-target object is charged by applying voltage to the charging electrode;
the voltage application means applies to the charging electrode a voltage higher than or equal to an ion production threshold voltage; and
the charging electrode is separated from the charge-target object by such a distance that the charge-target object can be charged by ions produced by the voltage applied to the charging electrode, the distance being greater than a corona discharge threshold distance.

3. A charging device, comprising:
a charging electrode positioned so as not to contact a charge-target object provided inside an electrophotographic apparatus; and
voltage application means for applying voltage to the charging electrode,
wherein:
the charge-target object is charged by applying voltage to the charging electrode; and
the voltage application means applies to the charging electrode a voltage higher than or equal to an ion production threshold voltage and less than an ozone production surge threshold voltage at which ozone starts to be produced in a suddenly increasing quantity.

4. A charging device, comprising:
a charging electrode positioned so as not to contact a charge-target object provided inside an electrophotographic apparatus; and
voltage application means for applying voltage to the charging electrode,
wherein:
the charge-target object is charged by applying voltage to the charging electrode;
the voltage application means applies to the charging electrode a voltage higher than or equal to an ion production threshold voltage; and
the charging electrode is separated from the charge-target object by such a distance that the charge-target object can be charged by ions produced by the voltage applied to the charging electrode, the distance being greater than an ozone production surge threshold distance at which ozone starts to be produced in a suddenly increasing quantity.

5. The charging device of claim 4, wherein the ozone production surge threshold distance is such a distance that the voltage which the voltage application means applies to the charging electrode equals an ozone production surge threshold voltage at which ozone starts to be produced in a suddenly increasing quantity.

6. The charging device of claim 3, wherein the ozone production surge threshold voltage is:
where there is inserted no resistor between the charging electrode and the voltage application means, a voltage at which a rate of increase of ozone production to an applied voltage reaches a maximum rate of change in a range from an ozone production threshold voltage, inclusive, to twice the ozone production threshold voltage, inclusive, the ozone production threshold voltage being a voltage at which ozone starts to be produced as the voltage applied to the charging electrode is being increased by a predetermined value at a time (if the rate of change at the ozone production threshold voltage is greater than or equal to twice the average of the rate of change over a range from the ozone production threshold voltage, exclusive, to twice the ozone production threshold voltage, inclusive, the ozone production surge threshold voltage equals the ozone production threshold voltage plus the predetermined value); and
where there is inserted a resistor between the charging electrode and the voltage application means, a voltage at which a rate of increase of ozone production to an applied voltage reaches a local maximum rate of change in a range from the ozone production threshold voltage, exclusive, to twice the ozone production threshold voltage, inclusive, the ozone production threshold voltage being a voltage at which ozone starts to be produced as the voltage applied to the charging electrode is being increased by a predetermined value at a time.

7. The charging device of claim 5, wherein the ozone production surge threshold voltage is:
where there is inserted no resistor between the charging electrode and the voltage application means, a voltage at which a rate of increase of ozone production to an applied voltage reaches a maximum rate of change in a range from an ozone production threshold voltage, inclusive, to twice the ozone production threshold voltage, inclusive, the ozone production threshold voltage being a voltage at which ozone starts to be produced as the voltage applied to the charging electrode is being increased by a predetermined value at a time (if the rate of change at the ozone production threshold voltage is greater than or equal to twice the average of the rate of change over a range from the ozone production threshold voltage, exclusive, to twice the ozone production threshold voltage, inclusive, the ozone production surge threshold voltage equals the ozone production threshold voltage plus the predetermined value); and
where there is inserted a resistor between the charging electrode and the voltage application means, a voltage at which a rate of increase of ozone production to an applied voltage reaches a local maximum rate of change in a range from the ozone production threshold voltage, exclusive, to twice the ozone production threshold voltage, inclusive, the ozone production threshold voltage being a voltage at which ozone starts to be produced as the voltage applied to the charging electrode is being increased by a predetermined value at a time.

8. A charging device, comprising:
a charging electrode positioned so as not to contact a charge-target object provided inside an electrophotographic apparatus; and
voltage application means for applying voltage to the charging electrode,
wherein:
the charge-target object is charged by applying voltage to the charging electrode; and
the voltage application means applies to the charging electrode a voltage higher than or equal to an ion production threshold voltage and less than a current surge threshold voltage at which an electric current which the voltage application means supplies to the charging electrode starts to suddenly increase.

9. A charging device, comprising:
a charging electrode positioned so as not to contact a charge-target object provided inside an electrophotographic apparatus; and
voltage application means for applying voltage to the charging electrode,
wherein:
the charge-target object is charged by applying voltage to the charging electrode;
the voltage application means applies to the charging electrode a voltage higher than or equal to an ion production threshold voltage; and
the charging electrode is separated from the charge-target object by such a distance that the charge-target object can be charged by ions produced by the voltage applied to the charging electrode, the distance being greater than a current surge threshold distance at which an electric current which the voltage application means supplies to the charging electrode starts to suddenly increase.

10. The charging device of claim 9, wherein the current surge threshold distance is such a distance that the voltage which the voltage application means applies to the charging electrode equals a current surge threshold voltage at which a current flow through the charging electrode starts to suddenly increase.

11. The charging device of claim 8, wherein the current surge threshold voltage is:
where there is inserted no resistor between the charging electrode and the voltage application means, a voltage at which a rate of increase of current flow through the charging electrode to an applied voltage reaches a maximum rate of change in a range from a current occurrence threshold voltage, inclusive, to twice the current occurrence threshold voltage, inclusive, the current occurrence threshold voltage being a voltage at which electric current starts to flow through the charging electrode as the voltage applied to the charging electrode is being increased by a predetermined value at a time (if the rate of change at the current occurrence threshold voltage is greater than or equal to twice the average of the rate of change over a range from the current occurrence threshold voltage, exclusive, to twice the current occurrence threshold voltage, inclusive, the current surge threshold voltage equals the current occurrence threshold voltage plus the predetermined value); and
where there is inserted a resistor between the charging electrode and the voltage application means, a voltage at which a rate of increase of current flow through the charging electrode to an applied voltage reaches a local maximum rate of change in a range from the current occurrence threshold voltage, exclusive, to twice the current occurrence threshold voltage, inclusive, the current occurrence threshold voltage being a voltage at which electric current starts to flow through the charging electrode as the voltage applied to the charging electrode is being increased by a predetermined value at a time.

12. The charging device of claim 10, wherein the current surge threshold voltage is:
where there is inserted no resistor between the charging electrode and the voltage application means, a voltage at which a rate of increase of current flow through the charging electrode to an applied voltage reaches a maximum rate of change in a range from a current occurrence threshold voltage, inclusive, to twice the current occurrence threshold voltage, inclusive, the current occurrence threshold voltage being a voltage at which electric current starts to flow through the charging electrode as the voltage applied to the charging electrode is being increased by a predetermined value at a time (if the rate of change at the current occurrence threshold voltage is greater than or equal to twice the average of the rate of change over a range from the current occurrence threshold voltage, exclusive, to twice the current occurrence threshold voltage, inclusive, the current surge threshold voltage equals the current occurrence threshold voltage plus the predetermined value); and
where there is inserted a resistor between the charging electrode and the voltage application means, a voltage at which a rate of increase of current flow through the charging electrode to an applied voltage reaches a local maximum rate of change in a range from the current occurrence threshold voltage, exclusive, to twice the current occurrence threshold voltage, inclusive, the current occurrence threshold voltage being a voltage at which electric current starts to flow through the charging electrode as the voltage applied to the charging electrode is being increased by a predetermined value at a time.

13. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by applying voltage to the charging electrode; and
the voltage application means applies to the charging electrode a voltage higher than or equal to an ion production threshold voltage and lower than a corona discharge threshold voltage.

14. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by applying voltage to the charging electrode;
the voltage application means applies to the charging electrode a voltage higher than or equal to an ion production threshold voltage; and
the charging electrode is separated from the charge-target object by such a distance that the charge-target object can be charged by ions produced by the voltage applied to the charging electrode, the distance being greater than a corona discharge threshold distance.

15. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by applying voltage to the charging electrode; and
the voltage application means applies to the charging electrode a voltage higher than or equal to an ion production threshold voltage and less than an ozone production surge threshold voltage at which ozone starts to be produced in a suddenly increasing quantity.

16. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by applying voltage to the charging electrode;
the voltage application means applies to the charging electrode a voltage higher than or equal to an ion production threshold voltage; and
the charging electrode is separated from the charge-target object by such a distance that the charge-target object can be charged by ions produced by the voltage applied to the charging electrode, the distance being greater than an ozone production surge threshold distance at which ozone starts to be produced in a suddenly increasing quantity.

17. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by applying voltage to the charging electrode; and
the voltage application means applies to the charging electrode a voltage higher than or equal to an ion production threshold voltage and less than a current surge threshold voltage at which an electric current which the voltage application means supplies to the charging electrode starts to suddenly increase.

18. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by applying voltage to the charging electrode;
the voltage application means applies to the charging electrode a voltage higher than or equal to an ion production threshold voltage; and
the charging electrode is separated from the charge-target object by such a distance that the charge-target object can be charged by ions produced by the voltage applied to the charging electrode, the distance being greater than a current surge threshold distance at which an electric current which the voltage application means supplies to the charging electrode starts to suddenly increase.

19. An electrophotographic image forming apparatus, comprising a charging device for use in charging a photoconductor,
the charging device includes:
a charging electrode positioned so as not to contact a charge-target object provided inside an electrophotographic apparatus; and
voltage application means for applying voltage to the charging electrode,
wherein:
the charge-target object is charged by ions produced by applying to the charging electrode a voltage higher than or equal to an ion production threshold voltage and less than an ozone production surge threshold voltage at which ozone starts to be produced in a suddenly increasing quantity.
